(19) United States
(12) Patent Application Publication
(10) Pub. No.: US 2025/0287461 A1
(43) Pub. Date: Sep. 11, 2025

(54) EPHEMERIS DATA FOR CONDITIONAL HANDOVER

(71) Applicant: TELEFONAKTIEBOLAGET LM ERICSSON (PUBL), Stockholm (SE)

(72) Inventors: Johan Rune, LIDINGÖ (SE); Jonas Sedin, BRENTFORD (GB)

(21) Appl. No.: 18/860,042

(22) PCT Filed: Apr. 25, 2023
(86) PCT No.: PCT/IB2023/054252

§ 371 Date: Oct. 25, 2024

Related U.S. Application Data
(60) Provisional application No. 63/334,538, filed on Apr. 25, 2022.

(51) Int. Cl. H04W 76/38; H04W 36/36

(52) U.S. Cl. CPC H04W 76/38; H04W 36/362

(57) ABSTRACT

According to certain embodiments, a method by a UE during a handover of the UE from a source cell associated with a source node to a candidate target cell associated with a candidate target node is provided. The method includes receiving, from the source node, a message including a handover command associated with the candidate target node associated with the candidate target cell. The handover command includes ephemeris data and at least one common TA parameter associated with the candidate target cell.

### TECHNICAL FIELD

The present disclosure relates, in general, to wireless communications and, more particularly, systems and methods using ephemeris data for Conditional Handover (CHO).

### BACKGROUND

In 3^{rd} Generation Partnership Project (3GPP) Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since 3GPP release 13, Narrowband-Internet of Things (NB-IoT) and LTE-Machine Type Communication (LTE-M) are part of the LTE specifications and provide connectivity to massive machine type communications (mMTC) services.

In 3GPP Release 15, the first release of the 5th Generation System (5GS) was specified. This is a new generation's radio access technology intended to serve use cases such as enhanced mobile broadband (eMBB), ultra-reliable and low latency communication (URLLC) and mMTC. 5th Generation (5G) includes the New Radio (NR) access stratum interface and the 5G Core Network (5GC). The NR physical and higher layers are reusing parts of the LTE specification and add needed components when motivated by the new use cases. One such component is the introduction of a sophisticated framework for beam forming and beam management to extend the support of the 3GPP technologies to a frequency range going beyond 6 GHz.

In Release 15, 3GPP also started the work to prepare NR for operation in a Non-Terrestrial Network (NTN). The work was performed within the Study Item “NR to support Non-Terrestrial Networks” and resulted in 3GPP TR 38.811. In Release 16, the work to prepare NR for operation in a Non-Terrestrial Network continued with the Study Item “Solutions for NR to support Non-Terrestrial Network” which resulted in 3GPP TR 38.821.

The Release 16 study item resulted in a Work Item being agreed for NR in Release 17, “Solutions for NR to support non-terrestrial networks (NTN)”, which is described in the Work Item Description RP-193234.

### Mobility in RRC_CONNECTED State

### “Regular” Handover (HO)/reconfiguration WithSync

In connected state, in the 3GPP specifications known as the RRC_CONNECTED state, the User Equipment (UE) has an active connection to the network for sending and receiving of data and signaling. In connected state, mobility is controlled by the network to ensure connectivity is retained to the UE with no interruption or noticeable degradation of the provided service as the UE moves between the cells within the network.

Connected state mobility is also known as HO. During the HO, the UE is moved from a source node using a source cell connection, to a target node using a target cell connection where the target cell connection is associated with a target cell controlled by the target node. In other words, during a HO, the UE moves from the source cell to a target cell. The source node and the target node may also be referred to as the source access node and the target access node or the source radio network node and the target radio network node. In the 5G system, the source node and the target node are referred to as the source gNodeB (gNB) and the target gNB.

As requested by the network, a UE in RRC_CONNECTED state is required to search and perform measurements on neighbor cells both on the current carrier frequency (intra-frequency) as well as on other carrier frequencies (inter-frequency). The UE does not take any autonomous decisions regarding when to trigger a HO to a neighbor cell (except to some extent when the UE is configured for CHO, as described below). Instead, the UE sends the measurement results from the measurements the UE performed on serving and neighboring cells to the network, and a decision is taken by the network as to whether or not to perform a HO to one of the neighbor cells. Thus, upon receiving a measurement report from the UE that indicates that it may be preferable to move the UE's Radio Resource Control (RRC) connection to a neighbor cell (e.g., because the measurement report indicates that the radio link in the service cell is deteriorating and/or that the radio channel quality in the neighbor cell has become (significantly) better than the radio channel quality in the serving cell), the network may send a message to the UE to instruct the UE to execute a HO. This message is an RRCReconfiguration message with a reconfigurationWithSync IE. The message is often informally referred to as a “handover command” (although a HandoverCommand is really an inter-gNB Radio Resource Control (RRC) message which is transferred in the “Target NG-RAN node To Source NG-RAN node Transparent Container” IE in the Handover Request Acknowledge XnAP message during preparation of an Xn HO and in the “Target to Source Transparent Container” IE in the Handover Request Acknowledge Next Generation Application Protocol (NGAP) message and the Handover Command NGAP message during preparation of an Next Generation (NG) HO).

In some cases, the source node and the target node are different nodes, such as different gNBs. Such a case is referred to as an inter-node or inter-gNB HO. In other cases, the source node and the target node are one and the same node, such as the same gNB. Such a case is referred to as an intra-node or intra-gNB HO and covers the case when the source and target cells are controlled by the same node. In yet another case, HO is performed within the same cell and, thus, also within the same node controlling or otherwise associated with that cell. These cases are referred to as intra-cell HO and may be performed to refresh security parameters.

It should also be understood that the source node (or source access node) and the target node (target access node) refer to a role served by a given access node during a HO of a specific UE. For example, a given gNB may serve as source gNB during HO of one UE, while it also serves as the target gNB during HO of a different UE. And, in case of an intra-node or intra-cell HO of a given UE, the same gNB serves both as the source gNB and target gNB for that UE.

An inter-node HO in NR can further be classified as an Xn-based or NG-based HO depending on whether the source and target node communicate directly using the Xn interface or indirectly via the Core Network (CN) (through one or two Application Management Function(s) (AMF(s))) using NG interfaces.

During an inter-node HO, after the HO decision has been made in the source gNB, the actual HO execution is preceded by a HO preparation phase consisting of communication between the source gNB and the target gNB. During this preparation phase, the source gNB provides the target gNB with state information related to the UE (referred to as the UE context), e.g. information about the UE's Packet Data Unit (PDU) session resources (e.g., Quality of Service (QOS) flow(s)) and various other configuration information, and the target gNB performs admission control (and assumedly accepts the HO) and returns indications of the admitted PDU session resources (e.g. QoS flow(s)) and the configuration the UE should apply when accessing the target cell. The UE configuration the target gNB provides is included in an inter-gNB RRC message called “HandoverCommand” and is formatted as an RRCReconfiguration message (including a reconfigurationWithSync IE). This RRCReconfiguration message (i.e., the handover command) is then forwarded by the source gNB to the UE and this triggers the UE to execute the HO (by releasing it connection in the source cell, synchronizing with the target cell, and initiating a RA procedure in the target cell to establish a connection). In the third message of the RA procedure in the target cell the UE sends an RRCReconfigurationComplete message (often referred to as a Handover Complete message) to acknowledge the RRCReconfiguration message that triggered the HO execution and to confirm the successful execution of the HO.

FIG. 1 illustrates a simplified signaling flow during an Xn-based inter-gNB HO in NR. The signaling is between the UE, the source gNB and the target gNB. A slightly more detailed signaling flow for the same Xn-based inter-gNB HO is illustrated in FIGS. 2A-2B. It is noted that control plane data (i.e., RRC messages such as the measurement report, HO command and handover complete messages) are transmitted on Signaling Radio Bearers (SRBs), while the user plane data is transmitted on Data Radio Bearers (DRBs).

As depicted in FIG. 1, the signalling may include:
301-302. The UE has an active connection to the source gNB where user data is sent and received to/from the network. Due to some trigger in the source gNB, e.g. a measurement report received from the UE, the source gNB decides to HO the UE to a target (neighbor) cell controlled by the target gNB.
303. The source gNB sends the XnAP HANDOVER REQUEST message to the target gNB passing a transparent RRC container with necessary information to prepare the HO at the target side. The information includes for example the target cell id, the target security key, the current source configuration and UE capabilities.
304. The target gNB prepares the HO and responds with the XnAP HANDOVER REQUEST ACKNOWLEDGE message to the source gNB, which includes the HO command (an RRCReconfiguration message containing the reconfiguration WithSync field) to be sent to the UE. The HO command includes configuration information that the UE should apply once it connects to the target cell, e.g., RA configuration, a new Cell-Radio Network Temporary Identifier (C-RNTI) assigned by the target node, security parameters, etc.
305. The source gNB triggers the HO by sending the HO command (received from the target gNB in the previous step) to the UE.
306. Upon reception of the HO command the UE releases the connection to the old (source) cell, starts the HO supervision timer T304, and starts to synchronize to the new (target) cell.
307-309. The source gNB stops scheduling any further downlink (DL) user data to the UE and sends the XnAP SN STATUS TRANSFER message to the target gNB indicating the latest Packet Data Convergence Protocol (PDCP) Secondary Node (SN) transmitter and receiver status. The source gNB now also starts to forward DL user data received from the CN to the target gNB, which buffers this data for now.
310. Once the UE the has completed the RA procedure in the target cell, the UE stops the T304 timer and sends the HO complete message to the target gNB.
311. Upon receiving the HO complete message, the target gNB starts sending (and receiving) user data to/from the UE. The target gNB requests the CN to switch the DL user data path between the User Plane Function (UPF) and the source node to the target node (communication to the CN is not shown in FIG. 1). Once the path switch is completed, the target gNB sends the XnAP UE CONTEXT RELEASE message to the source gNB to release all resources associated to the UE.

In FIG. 1, steps 301-304 are considered to be a part of the HO Preparation phase. Steps 305-310 are considered to be a part of the HO Execution phase, and step 311 is considered to be a part of the HO Complete phase.

Likewise, in FIG. 2, steps 0-5 are considered to be a part of the HO Preparation phase. Steps 6-8 are considered to be a part of the HO Execution phase, and steps 9-12 are considered to be a part of the HO Complete phase.

In NR, the following principles are used for HOs (or in more general terms, mobility in RRC_CONNECTED state):
Mobility in RRC_CONNECTED state is network-controlled as the network has the best information regarding the current overall situation, such as load conditions, resources in different nodes, available frequencies, etc. The network can also take into account the situation of many UEs in the network, from a resource allocation perspective.
The network prepares a target cell before the UE accesses that cell. The source gNB provides UE with the RRC configuration to be used in the target cell, including SRB1 configuration to send HO complete. The source gNB in turn receives this RRC configuration from the target gNB in the form of a HandoverCommand inter-node RRC message included in the HANDOVER REQUEST ACKNOWLEDGE XnAP message (where the HandoverCommand is included in the “Target NG-RAN node To Source NG-RAN node Transparent Container” IE).
In the RRC configuration, the target gNB provides to the UE via the source gNB, the target gNB configures the UE with a C-RNTI to be used in the target cell. The target gNB leverages this C-RNTI to identify the UE from Msg3 on Medium Access Control (MAC) level for the HO complete message (which is an RRCReconfigurationComplete message transmitted by the UE in the target cell to indicate the successful completion of the HO). Thus, there is no context fetching, unless a failure occurs, since the UE context was already transferred to the target gNB during the HO preparation (in the HANDOVER REQUEST XnAP message in the case of Xn HO).
To speed up the HO, the network provides needed information on how to access the target cell, e.g. RACH configuration, so the UE does not have to acquire System Information (SI) (other than the Master Information Block (MIB)) prior to the HO. This information is included in the HandoverCommand and, thus, in the target cell RRC configuration sent to the UE.
The UE may be provided with contention free random access (CFRA) resources (in the above mentioned RRC configuration forwarded to the UE by the source gNB). The CFRA resources consist of one or more CFRA preamble(s) and may also contain CFRA occasions (i.e., Physical Random Access Channel (PRACH) transmission resources that are not included in the common PRACH configuration). In that case, the target gNB identifies the UE from the RA preamble (Msg1). The principle is that the procedure can always be optimized with dedicated resources.
Security is prepared before the UE accesses the target cell, i.e., security keys must be refreshed before sending the HO complete message (i.e., the RRCReconfigurationComplete message), so that new keys are used to encrypt and integrity protect the HO complete message, enabling verification in the target cell.
The target cell RRC configuration may be provided to the UE in two different forms: full configuration or delta configuration. In the former case, the provided RRC configuration is complete and self-contained, but a delta configuration only contains the configuration parts that are different in the target cell than in the source cell. The advantage of delta configuration is that the size of the HandoverCommand can be minimized.

### Conditional Handover (CHO)

As previously described, HO typically occurs when the channel quality of the serving cell is degrading. The network is in control and bases the HO decision on measurement reports from the UE. In a typical case, the UE is configured to send a measurement report when an A3 event (e.g., a neighbor cell quality becomes better than serving cell quality) is fulfilled. This will then trigger the gNB to decide to pursue a HO for the UE with the target cell being selected based on the reported neighbor cell measurements. If this is an inter-gNB neighbor cell, the serving gNB initiates the HO preparation by sending a HO Request XnAP message to the neighbor gNB and the neighbor gNB responds with a HO Request Acknowledge XnAP message containing, in the form of a HandoverCommand, the RRC configuration the UE should apply when connecting to the target cell. The serving (source) gNB then forwards the HandoverCommand to the UE as an RRCReconfiguration message. When the UE receives this message, it releases the source cell and starts the procedure of connecting to the target cell (i.e., synchronizing with the target cell and performing RA).

However, given the typical circumstances for HO, i.e., that the channel quality in the serving (source) cell is deteriorating, the HO operation is quite susceptible to errors. FIGS. 3A-3B illustrate two error cases that are addressed by the CHO concept. Specifically, As FIG. 3A illustrates, one potential error associated with HO is that the measurement report from the UE, which would trigger the gNB to initiate the HO, never reaches the gNB because of too many transmission/reception errors. As FIG. 3B illustrates, another potential error is that all HO preparations are successful, but the gNB fails to reach the UE with the RRCReconfiguration message constituting the HO Command. Both these errors are typically caused by a serving cell channel quality degrading faster than expected.

To combat such errors, a special variant of HO called CHO was introduced in 3GPP Release 16. The CHO feature allows the serving gNB to configure a UE to autonomously trigger HO execution, when a HO execution condition (or trigger condition) configured by the serving gNB is fulfilled. To realize this feature, the serving gNB includes a HO execution condition-often referred to as a CHO execution condition-together with the HO Command forwarded from the candidate target gNB. This is configured in the condExecutionCond-r16 IE in the ASN. 1 code in the RRC specification 3GPP TS 38.331 version 16.7.0. See, 3GPP TS 38.331 version 16.7.0, 3rd Generation Partnership Project: Technical Specification Group Radio Access Network: NR: Radio Resource Control (RRC) protocol specification (Release 16).

Release 16 of the 3GPP standards supports configuration of two triggering events, which in the context of CHO are referred to as conditional events (CondEvents). The supported CondEvents are CondEvent A3 and CondEvent A5 which are reused from the A3 and A5 events of the Radio Resource Management (RRM) framework. When used as CondEvents, A3 is defined as “Conditional reconfiguration candidate becomes amount of offset better than Primary Cell (PCell)/Primary Secondar Cell (PSCell)” and A5 is defined as “PCell/PSCell becomes worse than absolute threshold1 AND Conditional reconfiguration candidate becomes better than another absolute threshold2”. Furthermore, the specification also allows the combination of two events, whose conditions both have to be fulfilled for the duration of the configured time-to-trigger period, in order for the CHO execution to be triggered.

CHO is applicable for both intra-gNB HO and inter-gNB HO. The following discussion focuses on the feature in the inter-gNB CHO case, since this is the most comprehensive and challenging case which best illustrates the complete concept.

When the UE receives the RRCReconfiguration message including configuration of a CHO (i.e., including a HO Command and an associated CHO execution condition, it does not initiate execution of the HO, but instead remains connected to the serving cell, but begins to monitor the configured CHO execution condition (for the indicated candidate target cell). A cell associated with a CHO configuration (i.e. a cell which the UE may connect to if the CHO execution condition is fulfilled) may be referred to as a candidate target cell. Similarly, a gNB controlling or otherwise associated with a cell associated with a CHO configuration (i.e. a candidate target cell) may be referred to as a candidate target gNB.

The UE may be configured with multiple candidate target cells. For each candidate target cell, the UE is provided with an associated HO Command (i.e., an RRCReconfiguration to be applied if/when connecting to the candidate target cell) and an associated CHO execution condition.

If/when the CHO execution condition is fulfilled for a candidate target cell, the UE releases the source cell and starts executing the HO towards the candidate target cell (which then becomes the target cell) for which the associated CHO execution condition was fulfilled. From the UE's point of view, the rest of the procedure proceeds like a regular HO procedure, except that the UE discards all CHO configurations when it has successfully connected to the target cell.

On the network side, the serving/source gNB is not aware of if or when a CHO execution condition is fulfilled for the UE, i.e., the UE will silently release the source cell. Therefore, after HO completion, i.e., after successful RA and successful reception of the RRCReconfigurationComplete message (which often is referred to as the HO Complete message), the target gNB sends a HANDOVER SUCCESS XnAP message to the source gNB. This informs the source gNB that the UE has left the source cell and successfully completed a HO to the target cell. If multiple candidate target gNBs were prepared for CHO for the UE, the source gNB can cancel the CHO preparations in the other (non-selected) candidate target gNBs using the HANDOVER CANCEL XnAP message, so that these gNBs can release any reserved resources.

During a regular HO, the source gNB starts to forward user plane data arriving in the source gNB to the target gNB (for further forwarding to the UE) as soon as the HO Command is sent to the UE. In CHO, however, due to the uncertainty of if and when the UE will actually execute a HO, it may be suboptimal to start forwarding user plane data to a candidate target gNB upon transmission of the HO Command, since this will cause unnecessary load on the Xn user plane, as well as processing load in the candidate target gNB. Therefore, the source gNB can choose not to initiate user plane forwarding until it receives the HANDOVER SUCCESS XnAP message from the target gNB. On the other hand, not initiating user plane forwarding until the HANDOVER SUCCESS XnAP message is received delays the availability of buffered DL data in the target gNB, which increases the HO interruption time. Therefore, both options are available for CHO, referred to as early data forwarding (any time after transmission of the HO Command and before reception of the HANDOVER SUCCESS XnAP message) and late data forwarding (upon reception of the HANDOVER SUCCESS XnAP message).

FIG. 4 illustrates the CHO procedure. The RRCReconfiguration* indicated with an asterisk (***) is the HO Command containing the RRC reconfiguration the UE shall apply if/when connecting to the candidate target gNB in the selected target cell.

FIGS. 5A-5B illustrate a more detailed signaling diagram for the CHO procedure. Specifically, the principle for CHO, as defined in 3GPP TS 38.300 Release 16 version 16.8.0, is illustrated in FIGS. 5A-5B.

Steps 0-7 are considered to be a part of the HO Preparation phase. Specifically, a measurement report is received from the UE in, for example, a MeasurementReport RRC message, at step 1 in FIG. 5A. At step 2, and based on the measurement report of step 1, the source node decides to configure the UE for CHO.

At step 3, the source node prepares one or potentially more candidate target nodes by including a CHO indicator and the current UE configuration in the HANDOVER REQUEST XnAP message sent over Xn. Unlike a regular HO (non-CHO), CHO enables the network to prepare the UE with more than one candidate target cell. Each candidate target cell has its own target cell configuration (RRCReconfiguration) and its own CHO execution condition. The target cell configuration is generated by the candidate target node while the CHO execution condition is configured by the source node. For CHO in 3GPP Release 16, the CHO execution condition may consist of one or two trigger conditions such as, for example, the A3 and A5 signal strength/quality based events defined in 3GPP TS 38.331 version 16.7.0.

As in a regular (non-CHO) HO, the HO command (RRCReconfiguration message) sent to the UE, in step 6, is generated by the candidate target node but transmitted to the UE in the source cell by the source node. In case of an inter-node HO (as is depicted in FIGS. 5A-5B), the HO command is sent from the candidate target node to the source node within the HANDOVER REQUEST ACKNOWLEDGE XnAP message, at step 5, as a transparent container (specified as the HandoverCommand inter-node RRC message in 3GPP TS 38.331 version 16.7.0), meaning that the source node does not change the content of the HO command.

The target cell configuration (the RRCReconfiguration for the UE to use in the candidate target cell) and the CHO execution condition for each candidate target cell provided by the network to the UE may collectively be referred to as a CHO configuration, or, alternatively, each combination of candidate target cell, target cell configuration and CHO execution condition may be referred to as a CHO configuration (i.e., the terminology is not consistent). When received by the UE in the HO command (RRCReconfiguration message in step 6), the target cell configuration is not applied immediately as in a regular (non-CHO) HO. Instead, the UE starts to evaluate the CHO execution condition(s) configured by the network.

The network may configure the UE with one or two trigger conditions (A3 and/or A5 event) per CHO execution condition and candidate target cell. If the UE is configured with two trigger conditions, then both events need to be fulfilled to trigger the UE to execute the CHO towards the candidate target cell.

When the CHO execution condition is fulfilled for one of the candidate target cells, the UE releases its source cell connection, applies the associated target cell configuration (RRCReconfiguration), and starts the HO supervision timer T304. The UE now connects to the target node as in a regular HO, in step 8. Any CHO configuration stored in the UE is released after completion of the (conditional) HO procedure.

At step 8a, the target node sends the HANDOVER SUCCESS XnAP message over Xn to the source node to inform the source node that the UE has successfully accessed the target cell. Triggering of data forwarding to the target node is typically done after receiving the HANDOVER SUCCESS XnAP message in the source node—this is also known as “late data forwarding”. As an alternative, data forwarding may be triggered at an earlier stage in the HO procedure, after receiving the RRCReconfigurationComplete message from the UE at step 7). This mechanism is also known as “early data forwarding”.

If more than one candidate target cell was configured during the HO Preparation phase, then the source node needs to cancel the CHO for the candidate target cells not selected by the UE. At step 8c, the source node sends the HANDOVER CANCEL XnAP message over Xn on the other signaling connection(s) and/or the other candidate target node(s) to cancel the CHO and thus to initiate a release of the reserved resources in the target node(s).

During a regular HO (i.e., a non-CHO), if the HO attempt fails due to, for example, a radio link failure or expiry of timer T304, the UE will typically perform a cell selection and continue with an RRC re-establishment procedure. But when a CHO execution attempt fails and the selected cell happens to be a candidate target cell included in the CHO configuration, the UE will instead attempt a CHO execution to the selected cell. This UE behavior is however enabled/disabled by means of network configuration.

### Satellite Communications

There is an ongoing resurgence of satellite communications. Several plans for satellite networks have been announced in the past few years. The target services vary, from backhaul and fixed wireless, to transportation, to outdoor mobile, to IoT. Satellite networks could complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest, which has been reflected in the 3GPP standardization work. In 3GPP Release 15, 3GPP started the work to prepare NR for operation in a Non-Terrestrial Network (NTN). The work was performed within the study item “NR to support Non-Terrestrial Networks” and resulted in 3GPP TR 38.811. In 3GPP Release 16, the work to prepare NR for operation in an NTN network continued with the study item “Solutions for NR to support Non-Terrestrial Network”, which has been captured in 3GPP TR 38.821. In parallel the interest to adapt NB-IoT and LTE-M for operation in NTN is growing. As a consequence, 3GPP Release 17 contains both a work item on NR NTN and a study item on NB-IoT and LTE-M support for NTN.

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite.
Access link, or service link, that refers to the link between a satellite and a UE.

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

Two basic architectures can be distinguished for satellite communication networks, depending on the functionality of the satellites in the system:
Transparent payload (also referred to as bent pipe architecture). The satellite forwards the received signal between the terminal and the network equipment on the ground with only amplification and a shift from uplink (UL) frequency to DL frequency. When applied to general 3GPP architecture and terminology, the transparent payload architecture means that the gNB is located on the ground and the satellite forwards signals/data between the gNB and the UE
Regenerative payload. The satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP Release 17, only the transparent payload architecture is considered.

FIG. 6 illustrates an example architecture of a satellite network with bent pipe transponders (i.e. the transparent payload architecture). The gNB may be integrated in the gateway or connected to the gateway via a terrestrial connection (e.g., wire, optic fiber, wireless link, etc.).

The significant orbit height means that satellite systems are characterized by a path loss that is significantly higher than what is expected in terrestrial networks. To overcome the pathloss it is often required that the access and feeder links are operated in line-of-sight conditions, and that the UE is equipped with an antenna offering high beam directivity.

A communication satellite typically generates several beams over a given area. The footprint of a beam is usually in an elliptic shape, which has traditionally been considered as a cell, but cells consisting of the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

The NTN beam may in comparison to the beams observed in a terrestrial network provide a very wide footprint and may cover an area outside of the area defined by the served cell. Beam covering adjacent cells will overlap and cause significant levels of intercell interference, resulting from the slow decrease of the signal strength in the outwards radial direction. This is due in part to the high elevation angle and long distance to the network-side (satellite-borne) transceiver, which, compared with terrestrial cells, results in a comparatively small relative difference between the distance from the cell center to the satellite and the distance from a point at the cell edge to the satellite. To overcome the large levels of interference, a typical approach in NTN is to configure different cells with different carrier frequencies and polarization modes.

Three types of beams or cells are supported in NTN:
Earth-fixed beams/cells: provisioned by beam(s) continuously covering the same geographical areas all the time (e.g., in the case of GEO satellites).
Quasi-earth-fixed beams/cells: provisioned by beam(s) covering one geographic area for a limited period and a different geographic area during another period (e.g., in the case of NGSO satellites generating steerable beams).
Earth-moving beams/cells: provisioned by beam(s) whose coverage area slides over the earth surface (e.g., in the case of NGSO satellites generating fixed or non-steerable beams).

Herein, the terms beam and cell are used interchangeably, unless explicitly noted otherwise.

Of the three above cell types, quasi-earth-fixed cells and moving cells seem to be the ones most promising for actual deployment. In the case of moving cells, each cell (the footprint of its beam(s)) moves across the surface of the earth as its serving satellite moves along its orbit. In the case of quasi-earth-fixed cells, the cell area (as the name implies) remains fixed to the same geographical area, regardless of satellite movements. To enable this, a serving satellite has to have means for dynamically directing its beam(s), so that the same area of the earth is covered despite the satellite's movement. However, since the satellites orbit around the earth, the same satellite will only be able to cover the same area on the earth for a limited time, unless the satellite is in a geostationary orbit (and note that LEO satellites have the most traction in the satellite communication industry). This means that different satellites will have the task of covering a certain geographical cell area at different time periods. When this task is switched from one satellite to another, this in principle means that one cell is replaced by another, although covering the same area. As a consequence, all UEs connected in the old cell (i.e., UEs in RRC_CONNECTED state) have to be handed over (or otherwise moved, e.g. using RRC connection reestablishment) from the old to the new cell, and all UEs camping on the old cell (i.e., UEs in RRC_IDLE or RRC_INACTIVE state) have to perform cell reselection to the new cell.

In terms of such cell switches there are two alternative principles: 1) hard switch; and 2) soft switch. With hard switch, there is an instantaneous switch from the old cell to the new cell. Thus, the new cell appears at the same time as the old cell disappears. This makes completely seamless (i.e., interruption free) HO in practice impossible and creates a situation which may lead to overload of the access resources in the new cell due to potential access attempt peaks when many UEs try to access the new cell right after the cell switch. With soft switch, there is a time period during which the new and the old cell coexist (i.e., overlap), covering the same geographical area. This coexistence/overlap period allows some time for connected UEs to be handed over and for camping UEs to reselect to the new cell, which facilitates distribution of the access load in the new cell and thereby also provides better conditions for HOs with shorter interruption time. Soft switch is likely to be the most prevalent cell switch principle in quasi-earth-fixed cell deployments.

### Ephemeris Data

Ephemeris data is data that allows a UE (or other entity) to determine a satellite's position and velocity. More specifically, the ephemeris data contains parameters related to the satellite's orbit. There are several different formats defined for ephemeris data.

In 3GPP TR 38.821, it has been captured that ephemeris data should be provided to the UE, for example, to assist with pointing a directional antenna (or an antenna beam) towards the satellite and to calculate a correct Timing Advance (TA) and Doppler shift. Procedures on how to provide and update ephemeris data have not yet been studied in detail.

A satellite orbit can be fully described using 6 parameters. Exactly which set of parameters is chosen can be decided by the user: many different representations are possible. For example, a choice of parameters used often in astronomy is the set (α, ε, i, Ω, ω, t). Here, the semi-major axis a and the eccentricity ε describe the shape and size of the orbit ellipse: the inclination i, the right ascension of the ascending node Ω, and the argument of periapsis ω determine its position in space, and the epoch t determines a reference time (e.g., the time when the satellites moves through periapsis). FIG. 7 illustrates this set of parameters, which may also be referred to as orbital elements.

As an example of a different parametrization, the TLEs use mean motion n and mean anomaly M instead of a and t. A completely different set of parameters is the position and velocity vector (x, y, z, vₓ, v_{y}, v_{z}) of a satellite. These are sometimes called orbital state vectors. They can be derived from the orbital elements and vice versa, since the information they contain is equivalent. All these formulations (and many others) are possible choices for the format of ephemeris data to be used in NTN.

An aspect discussed during the 3GPP study item and captured in 3GPP TR 38.821 is the validity time of ephemeris data. Predictions of satellite positions in general degrade with increasing age of the ephemeris data used, due to atmospheric drag, maneuvering of the satellite, imperfections in the orbital models used, etc. Therefore, the publicly available data are updated quite frequently. For example, the update frequency depends on the satellite and its orbit and ranges from weekly to multiple times a day for satellites on very low orbits which are exposed to strong atmospheric drag and need to perform correctional maneuvers often. Even more frequent updates will be used in NR NTN (and IoT NTN) to allow the UE to determine/predict the satellite's position (and velocity) accurately enough to satisfy the requirements in NTN (e.g., to enable a UE to calculate an accurate enough UE-specific TA).

### GNSS

A Global Navigation Satellite System (GNSS) comprises a set of satellites orbiting the earth in orbits crossing each other, such that the orbits are distributed around the globe. The satellites transmit signals and data that allows a receiving device on earth to accurately determine time and frequency references and, maybe most importantly, accurately determine its position, provided that signals are received from a sufficient number of satellites (e.g., four). The position accuracy may typically be in the range of a few meters, but using averaging over multiple measurements, a stationary device may achieve much better accuracy.

A well-known example of a GNSS is the American Global Positioning System (GPS). Other examples are the Russian Global Navigation Satellite System (GLONASS), the Chinese BeiDou Navigation Satellite System and the European Galileo.

The transmissions from GNSS satellites include signals that a receiving device uses to determine the distance to the satellite. By receiving such signals from multiple satellites, the device can determine its position. However, this requires that the device also knows the positions of the satellites. To enable this, the GNSS satellites also transmit data about their own orbits (from which position at a certain time can be derived). In GPS, such information is referred to as ephemeris data and almanac data (or sometimes lumped together under the term navigation information).

The time required to perform a GNSS measurement (e.g. GPS measurement) may vary widely, depending on the circumstances, and mainly depending on the status of the ephemeris and almanac data the measuring devices has previously acquired, if any. In the worst case, a GPS measurement can take several minutes. GPS is using a bit rate of 50 bps for transmitting its navigation information. The transmission of the GPS date, time and ephemeris information takes 90 seconds. Acquiring the GPS almanac containing orbital information for all satellites in the GPS constellation takes more than 10 minutes. If a UE already possesses this information, the synchronization to the GPS signal for acquiring the UE position and Coordinated Universal Time (UTC) is a significantly faster procedure.

### 3GPP Dependence of GNSS for NR NTN and IoT NTN

To handle the timing and frequency synchronization in an NR or LTE based NTN a promising technique is to equip each device with a GNSS receiver. The GNSS receiver allows a device to estimate its geographical position. In one example, an NTN gNB carried by a satellite, or communicating via a satellite, broadcasts its ephemeris data (i.e., data that informs the UE about the satellite's position, velocity, and orbit) to a GNSS equipped UE. The UE can then determine the propagation delay, the delay variation rate, the Doppler shift, and its variation rate based on its own location (obtained through GNSS measurements) and the satellite location and movement (derived from the ephemeris data).

The GNSS receiver also allows a device to determine a time reference (e.g., in terms of Coordinated Universal Time (UTC)) and frequency reference. This can also be used to handle the timing and frequency synchronization in an NR or LTE based NTN. In a second example, an NTN gNB carried by a satellite, or communicating via a satellite, broadcasts its timing (e.g., in terms of a Coordinated Universal Time (UTC) timestamp) to a GNSS equipped UE. The UE can then determine the propagation delay, the delay variation rate, the Doppler shift, and its variation rate based on its time/frequency reference (obtained through GNSS measurements) and the satellite timing and transmit frequency.

The UE may use this knowledge to compensate its UL transmissions for the propagation delay and Doppler effect. The 3GPP Release 17 SID on NB-IoT and LTE-M for NTN supports this observation:
GNSS capability in the UE is taken as a working assumption in this study for both NB-IoT and eMTC devices. With this assumption, UE can estimate and pre-compensate timing and frequency offset with sufficient accuracy for UL transmission. Simultaneous GNSS and NTN NB-IoT/eMTC operation is not assumed.

Furthermore, in the NR NTN work item and IoT NTN work item for 3GPP Release 17, GNSS capability is assumed. Specifically, it is assumed that an NR NTN capable or IoT NTN capable UE also is GNSS capable and GNSS measurements at the UEs are essential for the operation of the NTN (e.g., the UEs are expected to compensate their UL transmissions for the propagation delay and Doppler effect).

### Consequences of Long Propagation Delay/RTT on the TA

Propagation delay is an important aspect of satellite communications its expected impact in NTN is different from the impacts of propagation delay in a terrestrial mobile system. For a bent pipe satellite network, the UE-gNB round-trip delay may, depending on the orbit height, range from a few or tens of ms in the case of LEO satellites to several hundreds of ms for GEO satellites. As a comparison, the round-trip delays in terrestrial cellular networks are typically below 1 ms.

The distance between the UE and a satellite can vary significantly, depending on the position of the satellite and, thus, the elevation angle & seen by the UE. Assuming circular orbits, the minimum distance is realized when the satellite is directly above the UE (ε=90°, and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ε=) 90°. Note that Table 1 assumes regenerative payload architecture. For the transparent payload case, the propagation delay between gateway and satellite needs to be considered as well, unless the base station corrects for that.

TABLE 1
Propagation delay for different orbital heights and elevation angles.

| | | | | One-way | | Propagation |
|---|---|---|---|---|---|---|
| Orbital | Elevation | Distance UE | | propagation | | delay |
| height | angle | <-> satellite | | delay | | difference |
| 600 km | 90° | 600 | km | 2.0 | ms | — |
| | 30° | 1075 | km | 3.6 | ms | 1.6 ms |
| | 10° | 1932 | km | 6.4 | ms | 4.4 ms |
| 1200 km | 90° | 1200 | km | 4.0 | ms | — |
| | 30° | 1999 | km | 6.7 | ms | 2.7 ms |
| | 10° | 3131 | km | 10.4 | ms | 6.4 ms |
| 35786 km | 90° | 35786 | km | 119.4 | ms | — |
| | 30° | 38609 | km | 128.8 | ms | 9.4 ms |
| | 10° | 40581 | km | 135.4 | ms | 16.0 ms |

The propagation delay may also be highly variable due to the high velocity of the LEO and MEO satellites and change in the order of 10-100 us every second, depending on the orbit altitude and satellite velocity.

The long propagation delays in NTN have many consequences, one of which being that large TA values have to be used (where a TA is the time a UE has to advance its UL transmission in relation to the corresponding frame, slot and symbol in the DL to achieve alignment between the UL and the DL frame/slot/symbol structure at an UL/DL alignment reference point, which typically is the gNB). In addition, due to the fast movement of the satellite (excluding GEO satellites), the TA will continuously change and will do so quite rapidly. 3GPP has dealt with these circumstances through a combination of new parameters and introduction of the principle of UE autonomous adaptation of the TA.

Typically, the network wants the UL and DL to be aligned at the gNB receiver, which means that the TA should be equal to the UE-gNB Round-Trip-Time (RTT). The UE-gNB RTT can be divided into two parts: the UE-satellite RTT (i.e., the service link RTT) and the gNB-satellite RTT (which is equal to the feeder link RTT assuming that the Gateway (GW) and the gNB are collocated). The satellite-gNB RTT is equal for all locations in the cell and, thus, the same for all UEs in the cell, whereas the UE-satellite RTT depends on the UE's location and thus is UE specific.

To take care of the part of the TA that is common for all UEs in the cell, the satellite broadcasts (in the SI, in a new System Information Block (SIB) with NTN specific data) so-called Common TA information, consisting of a Common TA value, the first time derivative of the Common TA value (denoted as “drift”) and the second time derivative of the Common TA value (denoted as “drift variation”). The UE specific part of the TA (i.e., the UE-satellite RTT) is left to the UE to autonomously calculate. To do this, the UE has to obtain its own location and the satellite position. The UE can obtain its own location using, for example, GNSS measurements, and the satellite's position (as well as its velocity) can be derived from the ephemeris data broadcast by the gNB (in the same SIB as the Common TA parameters). The ephemeris data and the Common TA parameters are nominally valid at a so-called epoch time, which is also indicated in the same SIB. Based on the ephemeris data, the UE can predict the satellite's position a certain time into the future, and the first and second time derivatives (i.e., the drift and drift variation parameters) of the Common TA allows the UE to calculate how the Common TA value changes with time. Furthermore, the broadcast ephemeris data and Common TA parameters have a limited validity time, which is also indicated in the same SIB. The ephemeris data and Common TA parameters the UE uses when calculating the UE specific TA have to be valid, i.e. their validity time must not have expired.

3GPP has also introduced support for the possibility to place the UL/DL alignment reference point at some other place than in the gNB. This support comes in the form of a parameter denoted as Kmac. The Kmac parameter takes care of the RTT between the gNB and the chosen UL/DL alignment reference point. Hence, Kmac=0 means that the UL/DL alignment reference point is located in the gNB, while other Kmac values will place the UL/DL alignment reference point somewhere between the gNB and the satellite. Kmac is included in the same SIB as the other above mentioned NTN specific configuration parameters. Broadcast of Kmac is optional and absence of a Kmac parameter in the concerned SIB implicitly means that Kmac=0 should be used.

When calculating the UE specific TA, the UE only uses the Common TA parameters, the ephemeris data and its own location. Thus, Kmac is not needed for this calculation. However, the UE needs to know Kmac for other purposes such as, for example, so that it can adapt certain timers to the UE-gNB RTT.

For Non-Terrestrial Networks (NTNs) using 3GPP technology, in particular 5G/NR, the long propagation delay means that the TA the UE uses for its UL transmissions is essential and has to be much greater than in terrestrial networks in order for the UL and DL to be time-aligned at the gNB (or at another point if Kmac>0), as is the case in NR and LTE. One of the purposes of the RA procedure is to provide the UE with a valid TA. However, even the RA preamble (i.e., the initial message from the UE in the RA procedure) has to be transmitted with a TA to allow a reasonable size of the RA preamble reception window in the gNB (and to ensure that the cyclic shift of the preamble's Zadoff-Chu sequence cannot be so large that it makes the Zadoff-Chu sequence, and thus the preamble, appear as another Zadoff Chu sequence, and thus another preamble, based on the same Zadoff-Chu root sequence), but this TA does not have to be as accurate as the TA the UE subsequently uses for other UL transmissions, where the TA has to be accurate enough to keep the timing error smaller than the cyclic prefix (CP).

In conjunction with the RA procedure, the gNB provides the UE with an accurate (i.e. fine-adjusted) TA in the Random Access Response (RAR) message (in 4-step RA) or MsgB (in 2-step RA), based on the time of reception of the RA preamble. In terrestrial NR, the gNB can subsequently adjust the UE's TA using a Timing Advance Command MAC CE (or an Absolute Timing Advance Command MAC CE), based on the timing of receptions of UL transmissions from the UE. A goal with such network control of the UE's TA is typically to keep the time error of the UE's UL transmissions at the gNB's receiver within the cyclic prefix (which is required for correct decoding of the UL transmissions (e.g., on the PUSCH and the PUCCH). The TA control framework also includes a time alignment timer with which the gNB configures the UE. The time alignment timer is restarted every time the gNB adjusts the UE's TA and if the time alignment timer expires, the UE is not allowed to transmit in the UL without a prior RA procedure (which serves the purpose to provide the UE with a valid TA). For NTN, 3GPP has also agreed that in addition to the gNB's control of the UE's TA, the UE is allowed to autonomously update its TA based on estimation of changes in the UE-gNB RTT (using the UE's location and broadcast parameters related to the satellite orbit and the feeder link RTT, as previously described).

### NTN-Specific Information in the SI

Due to the special operating conditions in a NTN, the SI broadcast in an NTN cell has to include NTN-specific information. To serve this purpose, a new SIB will be introduced, which will include NTN-specific information. This NTN-specific SIB has often been referred to as “SIBXX” (or “SIBxx”) in 3GPP, but in the finalized first version of the concerned 3GPP Technical Specifications for NR, “XX” will probably be replaced by “19” (i.e., the NTN-specific SIB will be named SIB19 (or SIB19-r17 in the ASN.1 code)). Herein, this NTN-specific SIB is referred to as “SIBXX”.

According to a recent change request (CR) for NR NTN for 3GPP TS 38.331 version 16.7.0 (to be captured in version 17.0.0 of the same specification), i.e. R2-2201895, SIBXX is defined as follows:

| -- ASN1START | |
|---|---|
| SIBXX-r17 ::= SEQUENCE { | |
| ntn-Config | NTN-Config |
| OPTIONAL, -- Need R | |
| t-Service-r17 | INTEGER (0..549755813887) |
| OPTIONAL, -- Need R | |
| referenceLocation-r17 | OPTIONAL, -- |
| Need R | |
| ta-Report-r17 | ENUMERATED {enabled} |

OPTIONAL -- Need R
}
-- ASN1STOP

SIBXX field descriptions

ntn-Config
Provides Ephemeris data, common TA parameters, koffset, validity duration for UL sync information and
epoch time when included in SIBxx.
referenceLocation
Reference location of a cell provided via NTN quasi-Earth fixed system. FFS for exact field description.
ta-Report
Indicates whether UE specific TA reporting is enabled (see TS 38.321 [3], clause x.x.x).
t-Service
Indicates the time information on when a cell provided via NTN quasi-Earth fixed system is going to stop
serving the area it is currently covering. FFS“ This field is excluded when determining changes in system
information, i.e. changes of t-Service should neither result in system information change notifications nor in a
modification of valueTag in SIB1.”

Furthermore, the IE NTN-Config (or NTN-Config-r17) is defined as follows in the same CR:

-- ASN1START
-- TAG-NTN-CONFIG-START

| | |
|---|---|
| NTN-Config-r17 ::= | SEQUENCE { |
| epochTime-r17 | EpochTime-r17 |

OPTIONAL, -- Need R

| | |
|---|---|
| ntnUlSyncValidityDuration-r17 | ENUMERATED {s5, s10, s15, |

s20, s25, s30, s35,

s40, s45, s50,

s55, s60, s120, s180,

s240}

OPTIONAL, -- Need R

| | |
|---|---|
| cellSpecificKoffset-r17 | INTEGER (0..1023) |

OPTIONAL, -- Need R

| | |
|---|---|
| kmac-r17 | INTEGER (0..512) |

OPTIONAL, -- Need R

| | |
|---|---|
| tainfo-r17 | TAInfo-r17 |

OPTIONAL, -- Need R

| | |
|---|---|
| ntnPolarizationDL-r17 | ENUMERATED |
| {rhcp,lhcp,linear} | OPTIONAL, -- Need R |
| ntnPolarizationUL-r17 | ENUMERATED |
| {rhcp,lhcp,linear} | OPTIONAL, -- Need R |
| ephemerisInfo-r17 | EphemerisInfo-r17 |

OPTIONAL -- Need R
...
}

| | |
|---|---|
| EpochTime-r17 ::= | SEQUENCE { |
| sfn-r17 | INTEGER(0..1023), |
| subFrameNR-r17 | INTEGER(0..9) |

}

| | |
|---|---|
| TAInfo-r17 ::= | SEQUENCE { |
| taCommon-r17 | INTEGER(0..66485757), |
| taCommonDrift-r17 | INTEGER(−261935..261935) |

OPTIONAL, -- Need R

| | |
|---|---|
| taCommonDriftVariant-r17 | INTEGER(0..29470) |

OPTIONAL -- Need R
}
-- TAG-NTN-CONFIG-STOP
-- ASN1STOP

NTN-Config field descriptions

epochTime
Indicate the epoch time for assistance information (i.e. Serving satellite ephemeris in IE ephemerisInfo and
Common TA parameters). When explicitly provided through SIB, or through dedicated signaling, Epoch Time is
the starting time of a DL sub-frame, indicated by a SFN and a sub-frame number signaled together with the
assistance information. The reference point for epoch time of the serving satellite ephemeris and Common TA
parameters is the uplink time synchronization reference point.
cellSpecificKoffset
The CellSpecific_K_offset is a scheduling offset used for the timing relationships that need to be modified for
NTN [see TS 38.2xy]. The unit of K_offset is number of slots for a given subcarrier spacing of 15 kHz. FFS other
SCS
kmac
K_mac is a scheduling offset provided by network if downlink and uplink frame timing are not aligned at gNB. It is
needed for UE action and assumption on downlink configuration indicated by a MAC-CE command in PDSCH
[see TS 38.2xy]. When UE is not provided by network with a K_mac value, UE assumes K_mac = 0.
For the reference subcarrier spacing value for the unit of K_mac in FR1, a value of 15 kHz is used. The unit of
K_mac is number of slots for a given subcarrier spacing. FFS other SCS
ntnPolarizationDL
If present, this parameter indicates polarization information for Downlink transmission on service link: including
Right hand, Left hand circular polarizations (RHCP, LHCP) and Linear polarization
ntnPolarizationUL
If present, this parameter indicates Polarization information for Uplink service link.
If not present and ntnPolarizationDL is present, UE assumes a same polarization for UL and DL
ntnUISyncValidityDuration
A validity duration configured by the network for uplink synchronization assistance information (i.e. Serving
satellite ephemeris and Common TA parameters) which indicates the maximum time during which the UE can
apply assistance information without having acquired new assistance information.
The unit of ntnUISyncValidityDuration is second
taCommon
TACommon is a network-controlled common timing advanced value and it may include any timing offset
considered necessary by the network. TACommon with value of 0 is supported. The granularity of TACommon is
4.07 × 10\hat{ }(−3) μs. Values are given in unit of corresponding granularity
taCommonDrift
Indicate drift rate of the common TA. The granularity of TACommonDrift is 0.2 × 10\hat{ }(−3) μs/s Values are given
in unit of corresponding granularity
taCommonDriftVariant
Indicate drift rate variation of the common TA. The granularity of TACommonDriftVariation is 0.2 × 10\hat{ }(−4) μs/s\hat{ }2.
Values are given in unit of corresponding granularity

When 3GPP TS 38.331 version 17.0.0 is finalized, it is likely that SIBXX (which then probably will be SIB19) also will contain the parameter distance Thresh-r17, which will define a distance from referencelocation-r17, and which will be used to configure distance-based conditions (e.g. events and CondEvents).

It is not excluded that more NTN-specific SIB(s) will be introduced.

### CHO in NTN

Connected mode mobility challenges have been studied in the NTN study item phase for 3GPP Release 16 and are reported in 3GPP TR 38.821. Two of the challenges discussed in the Technical Report are frequent and unavoidable HOs (e.g., due to feeder link switch or cell switch in a quasi-earth-fixed cell deployments) and HO of a large number of UEs, both of which could result in significant control plane overhead and frequent service interruptions. This issue is perhaps most pronounced in the quasi-earth-fixed cell scenario when a geographic area is covered by a satellite (serving a cell covering the geographic area) for a limited time period while being replaced by a new satellite (serving a new cell covering the same geographic area) during the next time period, and so on. When the satellite covering the geographic area is replaced, the cell is also replaced, meaning that all the UEs connected in the old cell have to be handed over to the new cell, which potentially results in a high control signaling peak, because all the HOs have to occur in conjunction with the cell replacement (a.k.a. cell switch).

Hard and soft cell switch have been discussed in 3GPP, with preference for the soft switch case, wherein the old and the new cell both (simultaneously) cover the geographic area during a short overlap period, to simplify HOs with low interruptions.

To mitigate the expected signaling overhead at frequent HOs for a large number of UEs, 3GPP agreed to introduce support for CHO for NTN in 3GPP Release 17 with the CHO procedure and the trigger conditions as defined for NR in 3GPP Release 16 as a baseline.

In terrestrial networks, a UE can typically determine that it is near a cell edge by detecting a clear difference in the received signal strength (e.g., by performing Reference Signal Received Power (RSRP)-based measurements) compared to the received signal strength at the cell center.

In NTN deployments on the other hand, the difference in signal strength between the cell center and the cell edge is typically smaller. That is, the signal strength decreases slowly with the distance from the cell center (much smaller than in a typical terrestrial cell). This is often described as a “flat signal strength” or a “flat RSRP”. Thus, a UE may experience a small difference in signal strength between two beams (e.g., representing two cells) in a region of overlap. This may lead to suboptimal UE behaviors such as repetitive HOs (“ping-pong HOs”) back and forth between the two cells.

To avoid an overall reduction in HO robustness, 3GPP agreed to introduce the following trigger conditions (apart from the already existing trigger conditions, the A3 and A5 CondEvents) for CHO in NTN.
A new time-based trigger condition, defining a time period, or a time window, when the UE may execute CHO to a candidate target cell.
A new location-based trigger condition, defining a first distance threshold for the distance from the UE to a reference location in the source cell and a second distance threshold for the distance from the UE to a reference location in a candidate target cell, based on which the UE may trigger and execute CHO.
Reuse of the existing A4 event (neighbor becomes better than threshold) as defined in 3GPP TS 38.331 version 16.7.0, i.e., an A4 CondEvent is introduced.

The time-based trigger condition is defined by 3GPP as the time period [T1, T2] associated with each candidate target cell, where T1 is the starting point of the time period represented by a Coordinated Universal Time (UTC) and T2 is the end point of the time period represented by a time duration or a timer value, e.g., 10 seconds.

In the recent official change request (CR) for NR NTN for 3GPP TS 38.331 version 16.7.0 (to be captured in version 17.0.0 of the same specification), i.e., R2-2201895, the time-based condition (condEventT1-r17) is defined in ASN.1 in the ReportConfigNR IE as shown below:

| | |
|---|---|
| condEventT1-r17 | SEQUENCE { |

```
    t1-Threshold-r17
INTEGER (0..549755813887),
    duration-r17
INTEGER (1..6000)
  }
```

The duration encoded by the duration-r17 field indicates steps of 100 ms (i.e., it ranges from 100 ms to 10 minutes). It should be counted as starting from T1, which means that in principle T2=T1+duration=tl-Threshold-r17+duration-r17.

3GPP further agreed that the time-based trigger condition can only be configured in the UE in combination with one of the signal strength/quality based CondEvents A3, A4 or A5. This implies that the UE may only perform CHO to the candidate target cell in the time window defined by T1 and T2 if the signal strength/quality-based event is fulfilled within this time frame. The time-based condition AND the signal strength/quality-based condition must thus be fulfilled simultaneously in order for the UE to execute the CHO.

In 3GPP, discussions are still ongoing what the UE is supposed to do with the CHO configuration when the CHO execution condition has not been fulfilled (i.e., when CHO has not been triggered) for the candidate target cell when the time window expires, i.e., at the time T2.

Two alternatives have been discussed so far:
The UE discards the CHO configuration for the associated candidate target cell after T2.
The UE may keep the CHO configuration for the associated candidate target cell after T2. The CHO configuration may then be used in a potential recovery procedure, e.g., caused by a radio link failure (RLF) in the source cell followed by a cell selection (as the first action of an RRC connection re-establishment procedure), similar to the 3GPP release 16 UE behavior.

In addition to the time-based condition, 3GPP has also agreed to specify a location-based condition for CHO execution. The location-based condition is fulfilled if the UE's distance to a reference location of the serving (source) cell (assumedly representing the center of the serving/source cell) exceeds a first threshold while the distance to a reference location of a candidate target cell (assumedly representing the center of the candidate target cell) goes below a second threshold. Like the time-based condition, the location-based condition will be combined with one of the signal strength/quality-based CondEvents A3, A4 or A5, and both the location-based condition and the signal strength/quality-based condition have to be fulfilled for the CHO execution to be triggered.

There currently exist certain challenge(s), however. For example, in NTN, the configuration data provided to a UE in a cell is extended with NTN-specific configuration data, including, for example, the ephemeris data associated with the satellite serving the cell, the Common TA parameters, and Kmac applicable in the cell.

During a CHO involving a candidate target cell (possibly among other candidate target cells), the ephemeris data of the satellite serving the candidate target cell, as well as the Common TA and Kmac associated with the candidate target cell, are part of the configuration data a UE needs to access the candidate target cell if CHO execution is triggered towards the candidate target cell. It can also be feasible that the ephemeris data and Common TA parameters are provided by a central unit.

Thus, like other configuration data the UE needs to access a candidate target cell, e.g. the RA configuration, the ephemeris data of the satellite serving the candidate target cell, the Common TA, Kmac, and related parameters associated with the candidate target cell may be included in the RRCReconfiguration that the candidate target node prepares for the candidate target cell and which contains configuration data the UE should apply if/when accessing the candidate target cell. As previously described, this RRCReconfiguration is prepared by the target node, sent to the source node and forwarded to the UE (as a HO Command) to form part of a CHO configuration.

Notably, the ephemeris data and the Common TA parameters, which are both essential for a UE to initiate a RA procedure in a candidate target cell, have a limited validity time, which is a problem when these parameters are included in the HO Command (RRCReconfiguration) in a CHO configuration. The reason is that the CHO configuration, including the HO Command (RRCReconfiguration), may be stored a non-negligible time in the UE before the CHO is executed (if the CHO is executed), and during this time the validity time of the ephemeris data and Common TA parameters may expire.

To ensure that the UE has valid ephemeris data and Common TA parameters when accessing a candidate target cell, the UE has to be provided with an updated HO Command (RRCReconfiguration) whenever the validity time of the ephemeris data and Common TA parameters expire in the UE's CHO configuration. This will create a lot of signaling overhead involving inter-node signaling between the target node and the source node and signaling between the source node and the UE.

If, on the other hand, the ephemeris data and Common TA parameters are not included in the HO Command (RRCReconfiguration), if the CHO execution condition is fulfilled for a candidate target cell and the UE consequently is triggered to execute the CHO towards the candidate target cell, the UE will always have to start by acquiring the ephemeris data and Common TA parameters from a broadcast of an NTN-specific SIB in the candidate target cell before initiating the RA procedure in the candidate target cell, which obviously will increase the CHO execution delay and increase the interruption in the communication.

### SUMMARY

Certain aspects of the disclosure and their embodiments may provide solutions to these or other challenges. For example, certain embodiments relate to methods, systems, and techniques for making ephemeris data and Common TA parameters associated with a candidate target cell (and the satellite serving the candidate target cell) available to a UE in the CHO configuration without causing additional (or excessive additional) signaling overhead if the validity time of the ephemeris data and Common TA parameters expires.

According to certain embodiments, a method by a UE during a handover of the UE from a source cell associated with a source node to a candidate target cell associated with a candidate target node is provided. The method includes receiving, from the source node, a message including a handover command associated with the candidate target node associated with the candidate target cell. The handover command includes ephemeris data and at least one common TA parameter associated with the candidate target cell.

According to certain embodiments, during a handover of a UE from a source cell associated with a source node to a candidate target cell associated with a candidate target node, the UE is adapted to receive, from the source node, a message including a handover command associated with the candidate target node associated with the candidate target cell. The handover command includes ephemeris data and at least one common TA parameter associated with the candidate target cell.

According to certain embodiments, a method by a target node during a handover of a UE from a source cell associated with a source node to a candidate target cell associated with the target node is provided. The method includes transmitting, to the source node, a handover command for forwarding to the UE. The handover command includes ephemeris data and at least one common TA parameter associated with the candidate target cell.

According to certain embodiments, during a handover of a UE from a source cell associated with a source node to a candidate target cell associated with a target node, the target node is adapted to transmit, to the source node, a handover command for forwarding to the UE. The handover command includes ephemeris data and at least one common TA parameter associated with the candidate target cell.

According to certain embodiments, a method by a source node during a handover of a UE from a source cell associated with the source node to a candidate target cell associated with a target node is provided. The method includes receiving, from the target node, ephemeris data and at least one common TA parameter associated with the candidate target cell. The source node transmits, to the UE, the ephemeris data and the at least one common TA parameter associated with the candidate target cell.

According to certain embodiments, during a handover of a UE from a source cell associated with a source node to a candidate target cell associated with a target node, the source node is adapted to receive, from the target node, ephemeris data and at least one common TA parameter associated with the candidate target cell. The source node is adapted to transmit, to the UE, the ephemeris data and the at least one common TA parameter associated with the candidate target cell.

Certain embodiments may provide one or more of the following technical advantage(s). For example, certain embodiments may provide a technical advantage of making ephemeris data and Common TA parameters associated with a candidate target cell (and the satellite serving the candidate target cell) available to a UE in a CHO configuration without causing the additional signaling overhead if the validity time of the ephemeris data and common TA parameters expires.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a simplified signaling flow during an Xn-based inter-gNB HO in NR;

FIGS. 2A-2B illustrates a more detailed signaling flow during an Xn-based inter-gNB HO in NR:

FIGS. 3A-3B illustrate two error cases that are addressed by the CHO concept:

FIG. 4 illustrates a signaling diagram for a CHO procedure:

FIGS. 5A-5B illustrate a more detailed signaling diagram for the CHO procedure:

FIG. 6 illustrates an example architecture of a satellite network with bent pipe transponders:

FIG. 7 illustrates a set of parameters, which may also be referred to as orbital elements:

FIG. 8 illustrates an example communication system, according to certain embodiments:

FIG. 9 illustrates an example UE, according to certain embodiments:

FIG. 10 illustrates an example network node, according to certain embodiments:

FIG. 11 illustrates a block diagram of a host, according to certain embodiments:

FIG. 12 illustrates a virtualization environment in which functions implemented by some embodiments may be virtualized, according to certain embodiments:

FIG. 13 illustrates a host communicating via a network node with a UE over a partially wireless connection, according to certain embodiments:

FIG. 14 illustrates a method by a UE during a HO of the UE from a source cell associated with a source node to a candidate target cell associated with a candidate target node, according to certain embodiments, according to certain embodiments:

FIG. 15 illustrates a method by a target node during a HO of a UE from a source cell associated with a source node to a candidate target cell associated with the target node, according to certain embodiments; and

FIG. 16 illustrates a method by a source node during a HO of a UE from a source cell associated with the source node to a candidate target cell associated with a target node, according to certain embodiments, according to certain embodiments.

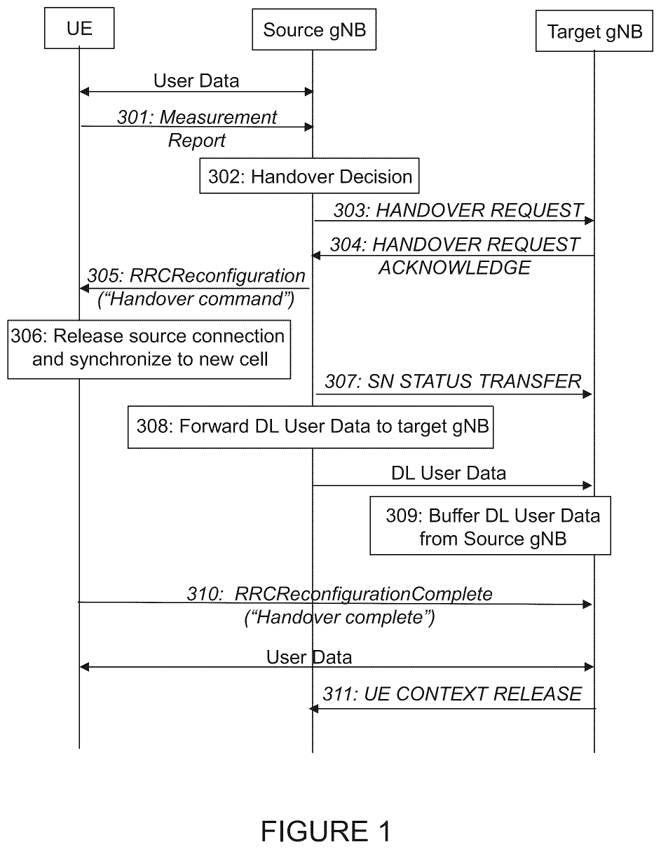

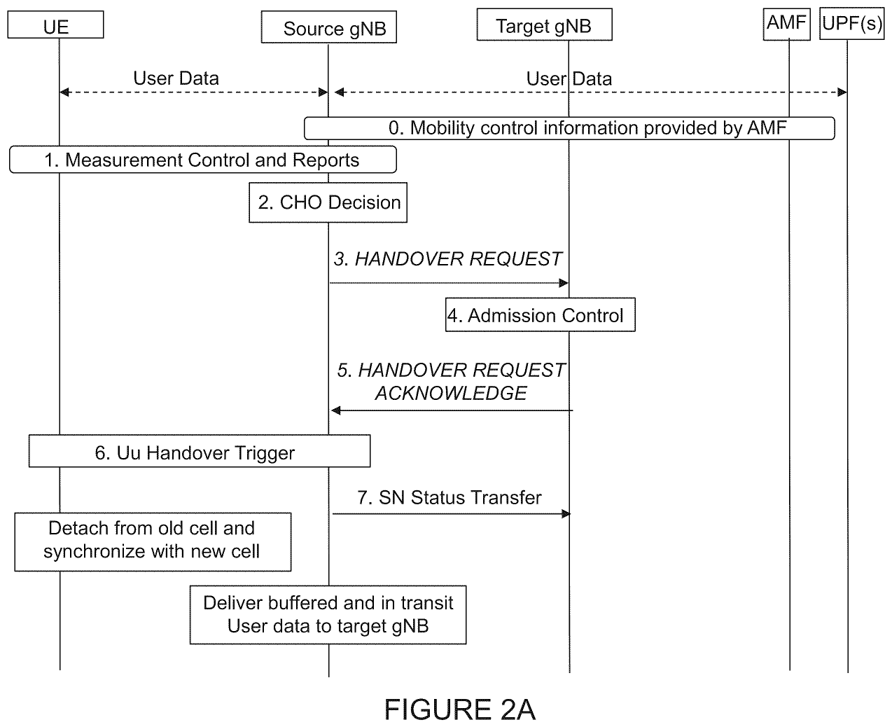

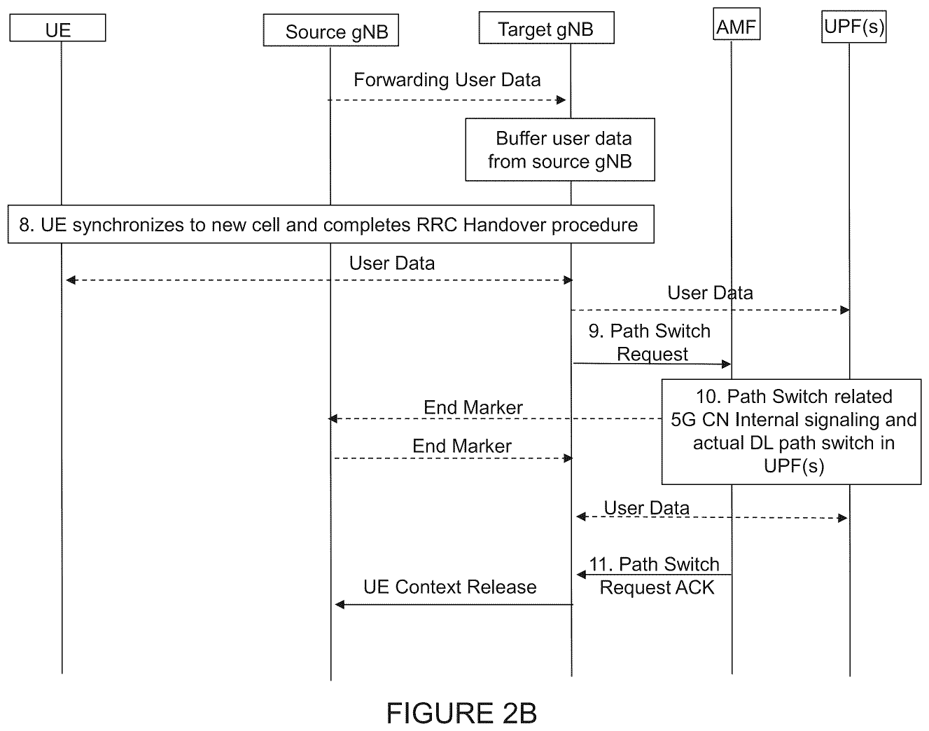

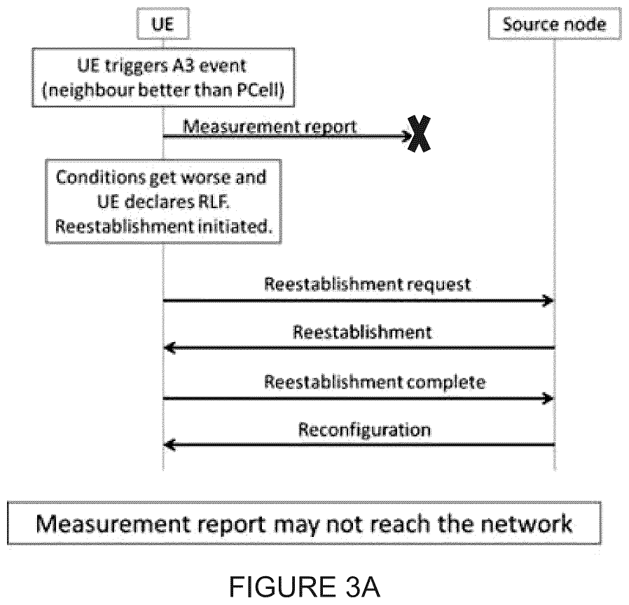

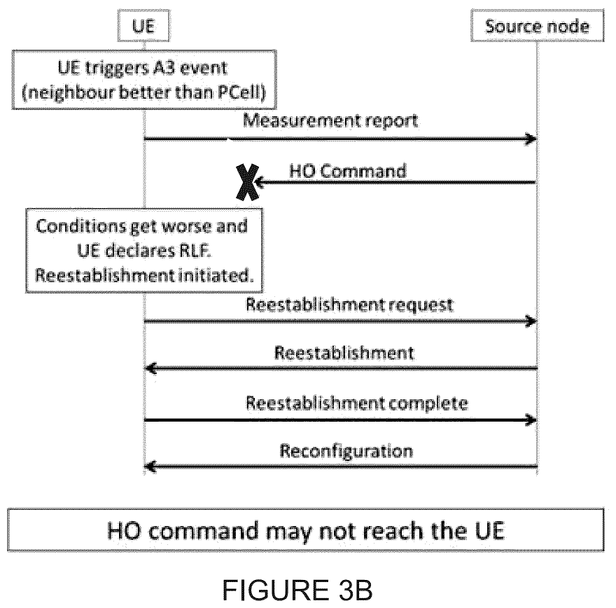

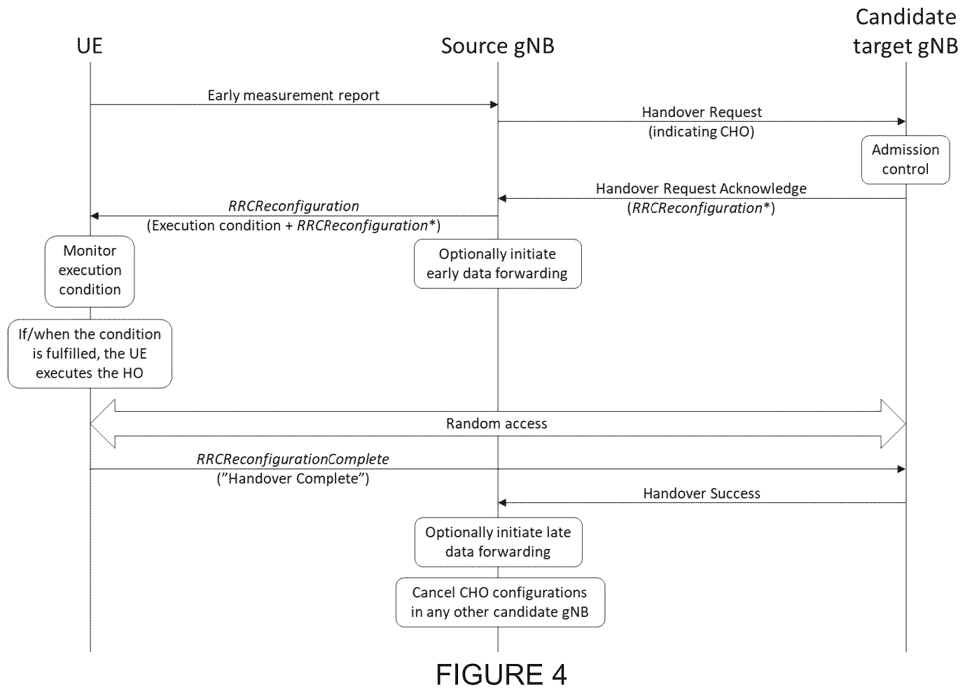

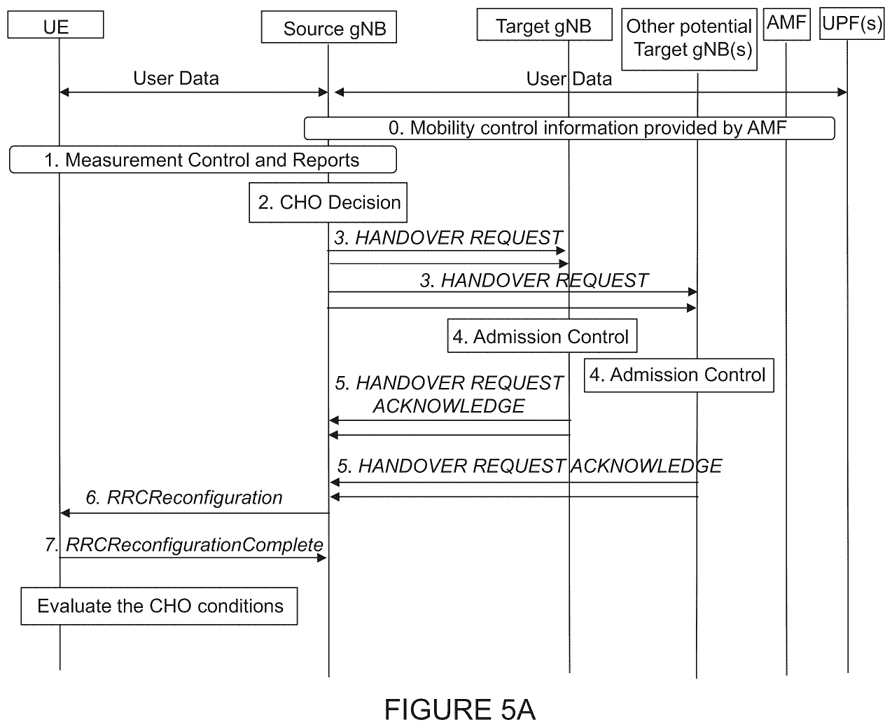

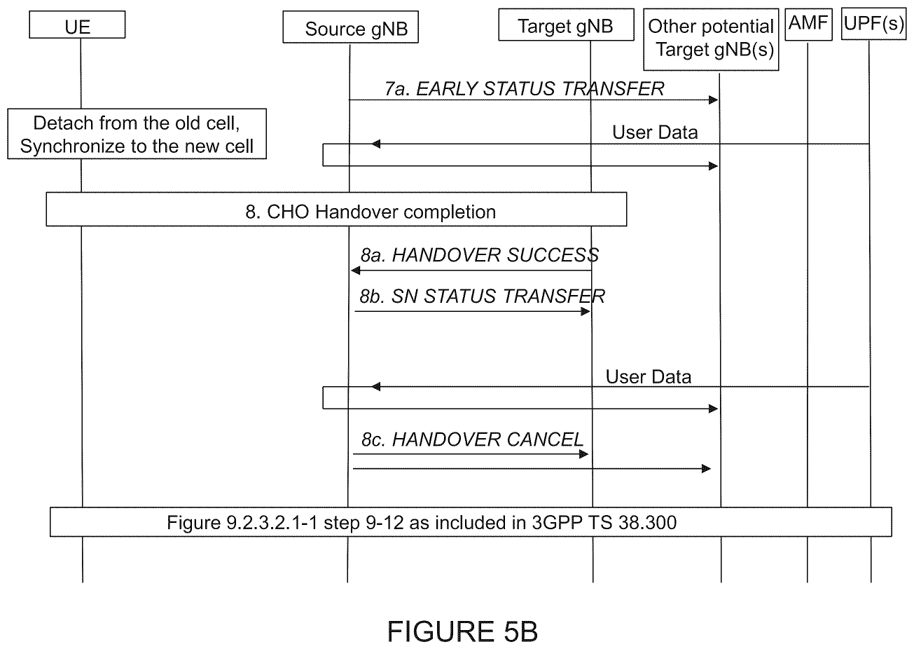

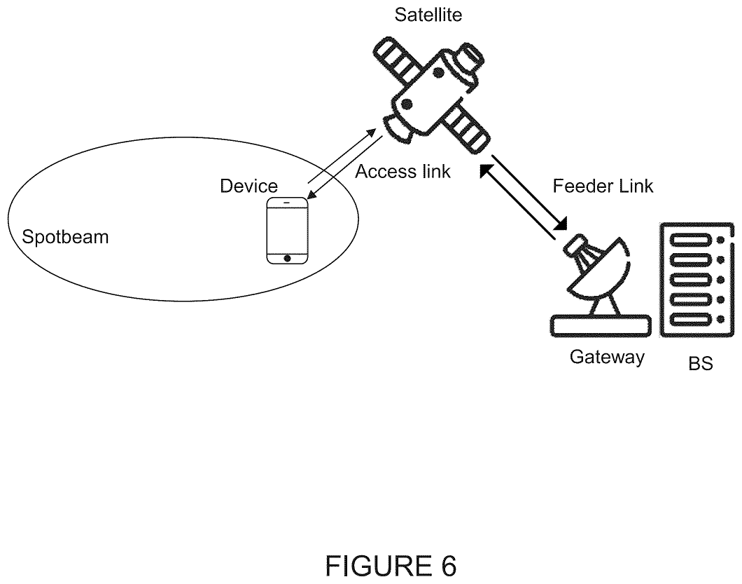

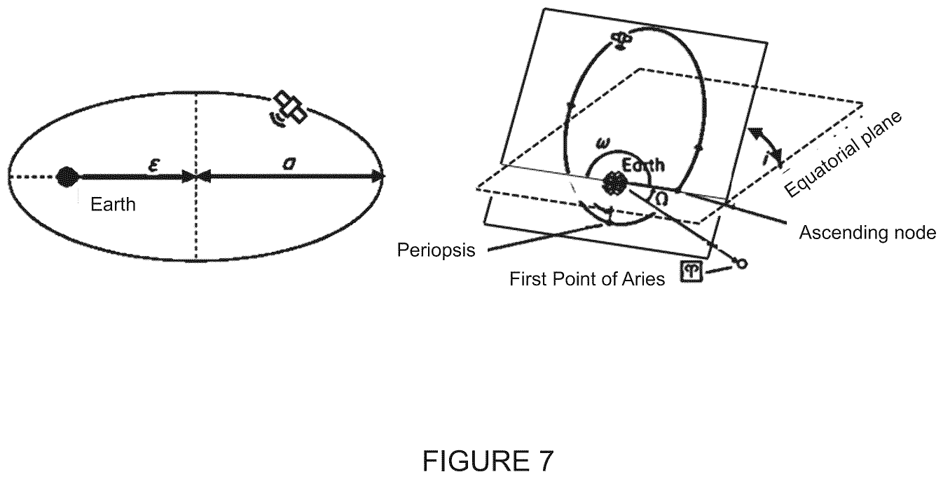

### DETAILED DESCRIPTION

Some of the embodiments contemplated herein will now be described more fully with reference to the accompanying drawings. Embodiments are provided by way of example to convey the scope of the subject matter to those skilled in the art.

Herein, unless explicitly stated otherwise, the term NTN refers to a NR NTN, i.e., an NTN that operates according to 3GPP NR technology adapted to satellite communications.

The embodiments outlined below are described mainly in terms of NR based (including IoT) NTNs, but they are equally applicable in an NTN based on LTE (including IoT) technology.

The term “network” is used in the solution description to refer to a network node, which typically will be an gNB (e.g. in a NR based NTN), but which may also be a eNB (e.g. in a LTE based NTN), or a base station or an access point in another type of network, or any other network node with the ability to directly or indirectly communicate with a UE.

As used herein, ‘node’ can be a network node or a UE. Examples of network nodes are NodeB, base station (BS), multi-standard radio (MSR) radio node such as MSR BS, eNodeB (cNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

The terms “source node”, “target node” and “candidate target node” are often used in the solution description. The “node” in these terms should be understood as typically being a RAN node in a NTN based on NR technology, LTE technology or any other RAT in which CHO or another conditional mobility concept is defined. In an NR based NTN, such a RAN node may be assumed to be a gNB. In an LTE based NTN (including an IoT NTN), such a RAN node may be assumed to be an eNB. Alternatives to, or refinements of, these interpretations are however also conceivable. For instance, a gNB may be an en-gNB, and if a split gNB architecture is applied (dividing the gNB into multiple separate entities or notes), the term “node” may refer to a part of the gNB, such as a gNB-CU (often referred to as just CU), a gNB-DU (often referred to as just DU), a gNB-CU-CP or a gNB-CU-UP. Similarly, an eNB may be an ng-eNB, and if a split eNB architecture is applied (dividing the gNB into multiple separate entities or notes), the term “node” may refer to a part of the eNB, such as an eNB-CU, an eNB-DU, an eNB-CU-CP or an eNB-CU-UP. Furthermore, the “node” in the terms may also refer to an IAB-donor, IAB-donor-CU, IAB-donor-DU, IAB-donor-CU-CP, or an IAB-donor-CU-UP.

When CHO is configured for a UE, a cell which the UE potentially can connect to (i.e., if the CHO execution condition is fulfilled for the cell) is denoted as “candidate target cell”. Similarly, a RAN node controlling or otherwise being associated with a candidate target cell is denoted as “candidate target node”. However, once the UE has detected a fulfilled CHO execution condition for a candidate target cell, this terminology becomes a bit blurred. At this point, during the actual execution of the CHO and when the UE has connected to the new cell, the concerned cell may be referred to as either a “candidate target cell” or a “target cell”. Similarly, a RAN node controlling or otherwise being associated with such a cell may, in this situation, be referred to as either a “candidate target node” or a “target node”.

A condition included in a CHO configuration governing the execution of the conditionally configured procedure may be referred to as a CHO execution condition, a HO execution condition, a CHO trigger condition, a HO trigger condition or sometimes just a trigger condition. Furthermore, phases of the procedure may be referred to as the HO Preparation phase, the HO Execution and/or the HO Completion phase, or may be referred to as the CHO Preparation phase (or the (conditional) HO Preparation phase), the CHO Execution phase and/or the CHO Completion phase.

The target cell configuration (the RRCReconfiguration for the UE to use in the candidate target cell) and the CHO execution condition for each candidate target cell provided by the network to the UE may collectively be referred to as a CHO configuration, or, alternatively, each combination of candidate target cell, target cell configuration and CHO execution condition may be referred to as a CHO configuration (i.e., the terminology is not consistent).

When writing message names of a communication protocol, two equivalent principles are used in this document. The writing principle “<protocol name><message name> message”, for example “XnAP HANDOVER CANCEL message”, and the writing principle “<message name><protocol name> message”, for example “HANDOVER CANCEL XnAP message” are equivalent, both referring to a message (i.e., “<message name>”) of a communication protocol (i.e., “<protocol name>”), e.g., the HANDOVER CANCEL message of the communication protocol XnAP. The same writing format equivalence applies to other communication protocols, such as NGAP.

During the HO Preparation phase, the source node sends an inter-node RRC message to the candidate target node, denoted as the HandoverPreparationInformation message. This inter-node RRC message contains the UE's configuration in the source cell, in particular the RRC related configuration. To convey the HandoverPreparation Information message to a candidate target node, the source node includes it in the HANDOVER REQUEST XnAP message (in case of an Xn based CHO) or in a HANDOVER REQUIRED NGAP message (in case of an NG based CHO), and in case of an NG based CHO, the core network (represented by an AMF) will forward it to the candidate target node in the HANDOVER REQUEST NGAP message. In this document, the term “Handover Preparation message”, or “initial Handover Preparation message”, is often used. This term may refer to a HandoverPreparationInformation inter-node RRC message, or a HANDOVER REQUEST XnAP message (including the HandoverPreparationInformation inter-node RRC message) or a HANDOVER REQUIRED/HANDOVER REQUEST NGAP message (including the HandoverPreparationInformation inter-node RRC message).

When accessing a target cell during a HO or a CHO, the first message the UE sends to the target node in the target cell, after having sent a RA preamble and having received a Random Access Response message, is an RRCReconfigurationComplete message, indicating the successful completion of the HO or CHO. It should be noted that this RRCReconfigurationComplete message is often referred to as a HO Complete message.

According to 3GPP agreements, a time-based CHO execution condition will always be combined with a signal strength/quality CHO execution condition (both of which have to be fulfilled to trigger CHO execution). However, all the embodiments in the proposed solution which do not assume that the UE monitors a signal strength/quality condition (i.e., an A3, A4 or A5 event), are equally applicable if the UE is configured only with a time-based CHO execution condition. (Note that in embodiments describing lack of trigger of the CHO execution within the time window (i.e., between T1 and T2) assume that a signal strength/quality condition is configured but not fulfilled between T1 and T2).

The term “Handover Preparation message” or “initial Handover Preparation message” may refer to a HandoverPreparationInformation inter-node RRC message, or a HANDOVER REQUEST XnAP message (including the HandoverPreparation Information inter-node RRC message) or a HANDOVER REQUIRED/HANDOVER REQUEST NGAP message (including the HandoverPreparationInformation inter-node RRC message).

The terms “HO Command” and “HandoverCommand” are used interchangeably herein. Both terms refer to a UE configuration the target node (of a regular HO) or candidate target node (of a CHO), during the (conditional) HO preparation phase, compiles for the UE to be subject to the HO or CHO. This UE configuration is compiled in the form of an RRCReconfiguration message which is conveyed to the UE via the source node. The RRCReconfiguration is associated with a certain target cell or candidate target cell and the UE applies the RRCReconfiguration when/if it accesses the concerned (candidate) target cell controlled by the (candidate) target node. Formally, “HandoverCommand” is an RRC inter-node message which is conveyed from a target node or a candidate target node to a source node during the preparation of a HO or a CHO. It is carried by the HANDOVER REQUEST ACKNOWLEDGE XnAP in the Target NG-RAN node To Source NG-RAN node Transparent Container IE. The “HandoverCommand” RRC inter-node message contains an RRCReconfiguration the UE should apply when accessing the target cell or candidate target cell. The source node forwards this RRCReconfiguration (i.e. the HandoverCommand) to the UE. In this solution description, the term “HandoverCommand” is also used to denote this RRCReconfiguration when it is stored in a UE as a part of a CHO configuration. This is also called the condRRCReconfig-r16 IE in the CondReconfigToAddMod-r16 IE (which contains the CHO configuration).

Ephemeris data is associate with (and applies to) a satellite. However, for convenience, ephemeris data may sometimes be described as associated with a cell, when the ephemeris data referred to actually is associated with the satellite serving the cell. This convenience practice may be seen e.g., in expressions like “a cell's ephemeris data” or “the ephemeris data of the cell”. Such expressions should be interpreted as short forms of more strictly correct expressions like “a cell's serving satellite's ephemeris data”, “the ephemeris data of the cell's serving satellite” or “the ephemeris data of the satellite serving the cell”.

The terms “remaining serving time”, “remaining service time” and “remaining time to serve” all refer to the remaining time a cell will keep providing coverage in the present area. In 3GPP documents, it is also referred to as “Tservice”, “tservice”, “t-Service” or “t-Service-r17”. An alternative indication of when the cell will stop serving the area is the “serving cell stop time”, which is also a term that may be used in the solution description. This concept is applicable (mainly) for quasi-earth-fixed cells, which is also the deployment scenario the proposed solution mainly targets. For a quasi-earth-fixed cell, the concept may also be formulated as the time remaining until the cell disappears.

Herein, a validity time is referred to as being associated with ephemeris data and Common TA parameters. e.g., broadcast as SI or provided in a CHO configuration. In the recent change request (CR) for NTN related changes in the NR RRC specification 3GPP TS 38.331 version 16.7.0 (to be captured in version 17.0.0 of the same specification), i.e. R2-2201895, this validity time is referred to as “ntn UlSync Validity Duration” (or “ntn UlSync Validity Duration-r17” or “ntn-UlSync Validity Duration-r17” in the ASN. 1 code).

Herein, it is often referred to a validity time associated with ephemeris data and Common TA parameters. Other information may also be associated with this validity time, such as a Kmac parameter (and potentially all the parameters that may be included in an NTN-specific SIB, often referred to as “SIBXX” (until “XX” is replaced by a number, which will probably be “19” in 3GPP released 17)), but this other information is generally not assumed to be equally dynamic as the ephemeris data and Common TA parameters, and hence, for convenience, the validity time is herein referred to as being associated with ephemeris data and Common TA parameter, while other possible associated information is not mentioned.

The methods, techniques and solutions herein are described in terms of CHO, but they are equally applicable to other conditional mobility procedures such as, for example, conditional PSCell addition and conditional PSCell change.

The description involves CHO procedures which primarily are described as Xn based CHOs (i.e., inter-gNB CHOs where a Xn interface is established between the gNBs) and the XnAP messages HANDOVER REQUEST and HANDOVER REQUEST ACKNOWLEDGE are used during the preparation of a CHO. However, the solution is also applicable when the CHO is prepared between gNBs which lack an established Xn interface, in which case the CHO preparation signaling is conveyed via the core network using NGAP messages (and possibly a protocol for messaging between two AMFs in the core network). In this case, the HANDOVER REQUEST XnAP message is replaced by the HANDOVER REQUIRED NGAP message and the HANDOVER REQUEST NGAP message, where the HANDOVER REQUIRED NGAP message is sent from the source node to the core network and the core network sends the relevant information further to the candidate target node in a HANDOVER REQUEST NGAP message. Similarly, the HANDOVER REQEUST ACKNOWLEDGE XnAP message is replaced by the HANDOVER REQUEST ACKNOWLEDGE NGAP message and the HANDOVER COMMAND NGAP message, where the HANDOVER REQUEST ACKNOWLEDGE NGAP message is sent from the candidate target node to the core network and the core network sends the relevant information further to the source node in a HANDOVER COMMAND NGAP message. When the messaging is passed via the core network, this may involve one or more AMF(s). If the source node and the candidate target node are connected to the same AMF, this AMF handles all the above described message receptions and transmissions. If the source node and the candidate target node are connected to different AMFs, these AMFs forward the information between each other using a core network protocol.

According to certain embodiments, an objective is to obtain a compromise wherein the ephemeris data and Common TA parameters associated with a candidate target cell (and the satellite serving the candidate target cell) may be available to a UE in the CHO configuration without causing the additional (or excessive additional) signaling overhead if the validity time of the ephemeris data and Common TA parameters expires. Multiple variants of the techniques described herein are described in more detail below.

In all embodiments, the candidate target node includes ephemeris data and Common TA parameters associated with a candidate target cell (and the satellite serving the candidate target cell) in the HandoverCommand, i.e., in the RRCReconfiguration associated with the candidate target cell in a CHO configuration (and which RRCReconfiguration the UE should apply if/when executing the CHO in the candidate target cell).

In a particular embodiment, if/when the CHO execution condition for a CHO configuration is fulfilled, the UE reads the RRCReconfiguration in the CHO and checks whether the validity time of the ephemeris data and the Common TA parameters has expired. If the validity time has not expired, the UE uses the ephemeris data and the Common TA parameters to calculate the TA to be used when the UE sends a RA preamble in the triggered candidate target cell. Otherwise, the UE obtains updated ephemeris data and Common TA parameters from the SI broadcast in the triggered candidate target cell before initiating the RA procedure in the triggered candidate target cell.

In another particular embodiment, a UE proactively checks/monitors the validity time(s) of the ephemeris data and Common TA parameters in its stored CHO configuration(s) even before any CHO execution condition has been fulfilled, and if the UE determines that a validity time has expired in a CHO configuration of a candidate target cell, the UE may (attempt to) proactively obtain updated ephemeris data and Common TA parameters from the SI broadcast in the candidate target cell.

In another particular embodiment, the candidate target node may choose to provide or not to provide an updated HandoverCommand to the source node (for further forwarding to the UE) when (or preferably before) the validity time of the ephemeris data and Common TA parameters expires (or is about to expire) in the previously sent HandoverCommand, e.g. based on circumstances such as the load on the Xn interface and/or the processing load in the candidate target node. Furthermore, the source node may have a choice whether to forward such an updated HandoverCommand to the UE, and the source node may also send information in the HANDOVER REQUEST XnAP message that impacts the candidate target node's choice of providing or not providing an updated HandoverCommand.

In another particular embodiment, in conjunction with the preparation of a CHO configuration with a time-based CHO execution condition (i.e., involving the times T1 and T2), the network may use this prediction ability to provide satellite ephemeris data and Common TA parameters with an associated epoch time equal to T1, or set to some time between T1 and T2. This may ensure, or at least increase the probability, that the ephemeris data and Common TA parameters are still valid if/when the UE executes the configured CHO.

These and other variants are described in more detail in the example scenarios provided below.

### First Example Scenario

According to certain embodiments, the candidate target node includes ephemeris data and Common TA parameters associated with a candidate target cell (and the satellite serving the candidate target cell) in the HandoverCommand, i.e. in the RRCReconfiguration associated with the candidate target cell in a CHO configuration (and which RRCReconfiguration the UE should apply if/when executing the CHO in the candidate target cell). The HandoverCommand is sent to the source node in a HANDOVER REQUEST ACKNOWLEDGE XnAP message, for further forwarding to the UE.

In a particular embodiment, expiration of the validity time associated with the ephemeris data and Common TA parameters in the HandoverCommand (i.e., the RRCReconfiguration in the CHO configuration, which RRCReconfiguration the UE is to apply if/when executing the CHO in the candidate target cell associated with the RRCReconfiguration) does not trigger the candidate target node to update the ephemeris data and Common TA parameters.

If/when the CHO execution condition is fulfilled for a CHO configuration, the UE reads the RRCReconfiguration in the CHO configuration (i.e., the RRCReconfiguration constituting the HandoverCommand) and checks whether the validity time of the ephemeris data and the Common TA parameters has expired. If the validity time has not expired, the UE uses the ephemeris data and the Common TA parameters to calculate the TA to be used when the UE sends a RA preamble in the candidate target cell for which the CHO execution condition was fulfilled (i.e. the triggered candidate target cell). If, on the other hand, the validity time has expired, the UE obtains updated ephemeris data and Common TA parameters from the SI broadcast in the triggered candidate target cell before initiating the RA procedure in the triggered candidate target cell (wherein the UE uses the obtained updated ephemeris data and Common TA parameters to calculate the TA the UE uses when sending the RA preamble in the triggered candidate target cell).

In a further particular embodiment, the UE does not wait until the CHO execution is triggered before it checks the status of the validity time in the CHO configuration, but does so proactively. Still, the UE does not proactively obtain SIBXX from the candidate target cell even if the UE detects that the validity time has expired, but instead the UE waits to do this until the CHO execution is triggered for the CHO configuration (if that ever happens).

In another particular embodiment, instead of the candidate target node, a central unit, such as an O&M node, or a node that is specific to NTN, such as a satellite command node or a satellite control node or satellite monitoring node, sends ephemeris data and/or Common TA parameters to the source node. This ephemeris data and/or Common TA parameters are associated with a satellite serving a candidate target cell in a CHO configuration for a UE. The source node sends the ephemeris data and/or Common TA parameters to the UE as part of a CHO configuration, albeit not included in the RRCReconfiguration (i.e. the HandoverCommand) in the CHO configuration (e.g. as fields/parameters in the CondReconfigToAddMod-r16 IE). In this scenario, the UE's behavior follows the same principles as described above.

The central node may provide ephemeris and Common TA information associated with multiple satellites (some or all of which may serve potential target cells for HO or potential candidate target cells for CHOs) and may do so regularly (e.g. periodically).

### Second Example Scenario

According to certain embodiments, the candidate target node includes ephemeris data and Common TA parameters associated with a candidate target cell (and the satellite serving the candidate target cell) in the HandoverCommand, i.e. in the RRCReconfiguration associated with the candidate target cell in a CHO configuration (and which RRCReconfiguration the UE should apply if/when executing the CHO in the candidate target cell). The HandoverCommand is sent to the source node in a HANDOVER REQUEST ACKNOWLEDGE XnAP message for further forwarding to the UE.

Similar to the first example scenario, expiration of the validity time associated with the ephemeris data and Common TA parameters in the HandoverCommand (i.e., the RRCReconfiguration in the CHO configuration, which RRCReconfiguration the UE is to apply if/when executing the CHO in the candidate target cell associated with the RRCReconfiguration) does not trigger the candidate target node to update the ephemeris data and Common TA parameters.

Furthermore, in a particular embodiment, a UE proactively checks/monitors the validity time(s) of the ephemeris data and Common TA parameters in its stored CHO configuration(s) even before any CHO execution condition has been fulfilled. If the UE determines that a validity time has expired in a CHO configuration of a candidate target cell, the UE may proactively obtain, or attempt to proactively obtain, updated ephemeris data and Common TA parameters from the SI broadcast in the candidate target cell. This option serves to reduce the delay (until the RA procedure can be initiated) if the CHO execution condition is subsequently fulfilled for the candidate target cell since the UE then can initiate the RA procedure in the triggered candidate target cell without first obtaining updated ephemeris data and Common TA parameters (i.e., without first obtaining SIBXX) from the SI of the triggered candidate target cell.

In certain examples, there may be a problem if the UE fails to read SI (SIBXX) of the target cell, which may for instance happen if the target cell is very far away. In a particular embodiment, however, the UE may remove the target cell from the configured CHO target cells either indefinitely or momentarily until the UE can reacquire the target cell SIBXX.

In a particular embodiment, instead of the candidate target node, a central unit, such as an O&M node, or a node that is specific to NTN, such as a satellite command node or a satellite control node or satellite monitoring node, sends ephemeris data and/or Common TA parameters to the source node. This ephemeris data and/or Common TA parameters are associated with a satellite serving a candidate target cell in a CHO configuration for a UE. The source node sends the ephemeris data and/or Common TA parameters to the UE as part of a CHO configuration, albeit not included in the RRCReconfiguration (i.e. the HandoverCommand) in the CHO configuration (e.g. as fields/parameters in the CondReconfigToAddMod-r16 IE).

The UE's behavior follows the same principles as described above.

The central node may provide ephemeris and Common TA information associated with multiple satellites (some or all of which may serve potential target cells for HO or potential candidate target cells for CHOs) and may do so regularly (e.g., periodically).

### Third Example Scenario

According to certain embodiments, the candidate target node includes ephemeris data and Common TA parameters associated with a candidate target cell (and the satellite serving the candidate target cell) in the HandoverCommand, i.e. in the RRCReconfiguration associated with the candidate target cell in a CHO configuration (and which RRCReconfiguration the UE should apply if/when executing the CHO in the candidate target cell). The HandoverCommand is sent to the source node in a HANDOVER REQUEST ACKNOWLEDGE XnAP message, for further forwarding to the UE.

In a particular embodiment, the candidate target node may choose to provide or not to provide an updated HandoverCommand to the source node (for further forwarding to the UE) when (or preferably before) the validity time of the ephemeris data and Common TA parameters expires (or is about to expire) in the previously sent HandoverCommand. To further reduce the signaling caused by such validity timer expirations, the candidate target node may choose to provide, or not to provide, such an updated HandoverCommand depending on the circumstances such as, for example, depending on the load on the Xn interface and/or the processing load in the candidate target node. The provision of the updated HandoverCommand to the source node may involve a cancellation of the CHO followed by preparation of a new CHO (wherein the candidate target node may cancel the CHO using a CONDITIONAL HANDOVER CANCEL XnAP message, e.g., with a cause value set to “CHO-CPC resources to be changed” or a new cause value indicating the specific reason, e.g. “Validity time expired” or “Ephemeris data and Common TA parameters validity time expired” or “Validity time about to expire” or “Ephemeris data and Common TA parameters validity time about to expire”) or may be performed using a (possibly new) XnAP message.

In a particular embodiment, the source node may choose whether to forward the updated HandoverCommand to the UE such as, for example, based on the load on the radio interface and the processing load in the source node.

However, giving the source node this flexibility is not without problems. If the updated HandoverCommand contains other updates than updates of the parameters associated with the validity time, then not sending the updated HandoverCommand to the UE would cause problems if/when the UE tries to access the candidate target node. To eliminate this problem, the candidate target node may send an indication to the source node together with the updated HandoverCommand, indicating whether the updated HandoverCommand contains update(s) of any data that is not associated with the validity time (wherein the validity time is associated with at least the satellite ephemeris data and Common TA parameters pertaining to a candidate target cell) or indicating whether the source node may choose not to forward the updated HandoverCommand to the UE.

In a further particular embodiment, the source node may have the possibility to indicate in the HANDOVER REQUEST XnAP message whether it will accept to forward updated HandoverCommands (or whether it will accept to forward updated HandoverCommands containing only updates of data associated with the validity time) from the candidate target node to the UE. As yet a further option, in a particular embodiment, the source node may have the possibility to indicate in the HANDOVER REQUEST XnAP message whether the candidate target node is allowed to provide updated HandoverCommands (or whether the candidate target node is allowed to provide updated HandoverCommands containing only updates of data associated with the validity time). If there is no Xn interface established between the source node and the candidate target node, the source node may, in each of these options, send the indication in a HANDOVER REQUIRED NGAP to the core network, and the core network then forwards the indication to the candidate target node in a HANDOVER REQUEST NGAP message.

In a further particular embodiment, when the candidate target node sends the HANDOVER REQUEST ACKNOWLEDGE XnAP message to the source node, including the HandoverCommand with the ephemeris data and Common TA parameters, the candidate target node also includes the validity time associated with the ephemeris data and Common TA parameters as an explicit IE in the HANDOVER REQEUST ACKNOWLEDGE XnAP message (i.e., outside the HandoverCommand (which is carried in the “Target NG-RAN node To Source NG-RAN node Transparent Container” IE)).

In a further particular embodiment, when the source node becomes aware of the validity time and if the source node determines that the validity time has expired, or is about to soon expire, the source node cancels the CHO in the candidate target node using a HANDOVER CANCEL XnAP message (possibly including a cause value indicating that the cause is that the validity time has expired or is about to expire), initiates a new CHO configuration towards the same candidate target cell, and sends this new CHO configuration to the UE as an updated CHO configuration.

As an alternative to canceling the CHO configuration and creating a new one, when determining that the validity time has expired or is about to soon expire, the source node may request the candidate target node to provide an updated HandoverCommand, which the source node, when having received it from the candidate target node, forwards to the UE as an update of the CHO configuration. This message exchange between the source node and the candidate target node may use new XnAP messages or may use the HANDOVER REQUEST XnAP message and the HANDOVER REQUEST ACKNOWLEDGE XnAP message with new IEs indicating this specific use of the messages.

In a further particular embodiment, the source node receives the ephemeris data and Common TA parameters from another central node and not the candidate target node. The central node would typically provide ephemeris and Common TA information associated with multiple satellites. This can for instance be an O&M node, or a node that is specific to NTN, such as a satellite command node or a satellite control node or satellite monitoring node. In this scenario, the source node provides the ephemeris data and Common TA parameters associated with a satellite serving a candidate target cell to the UE as a part of the CHO configuration, but not as a part of the RRCReconfiguration (i.e. the HandoverCommand) in the CHO configuration (e.g., as fields/parameters in the CondReconfigToAddMod-r16 IE).

In a particular embodiment, after having received updated ephemeris data and Common TA parameters, the source node decides whether to forward the updated ephemeris data and Common TA parameters to the UE. If this is received regularly from the central unit, then the source node can periodically update the CHO configuration, or only the ephemeris data and Common TA parameters part of the CHO configuration.

### Fourth Example Scenario

According to certain embodiments, the network may have access to more data related to a satellite's movements and orbit and/or more accurate such data than what is conveyed to the UEs in the ephemeris data. In such a scenario, the network may be expected to be able to more accurately predict a satellite's future movements and, thus, more accurately predict the satellite's position and velocity at a certain time in the future, possibly also using more elaborate prediction models (possibly implementation specific). Potentially, the network may also be able to at least partly correct the satellite's movement when it deviates from the predicted, or ideal, trajectory, which may further increase the accuracy in the network's prediction. In this context, the network may be represented by a gNB or an eNB or another network node, such as an O&M node or a satellite control and/or monitoring facility. Two or more such nodes may also cooperate to achieve the desired satellite trajectory/orbit prediction ability. For instance, a gNB or an eNB may request a satellite control/monitoring facility to provide the most up to data and accurate data available with regards to a satellite's movement. Another example may be that a gNB or an eNB requests another node, such as an O&M node or a satellite control/monitoring facility to provide a prediction of a certain satellite's trajectory, or the satellite's position and possibly velocity at a certain point in time in the future. Yet another example could be that an O&M node or a satellite control/monitoring center calculates a satellite's future trajectory and sends information describing this future trajectory a gNB or an eNB so that the gNB or eNB can derive ephemeris data (and Common TA parameters) from it to send to one or more UEs.

The network may use the above described prediction ability to determine ephemeris data for a satellite with an epoch time that occurs in the future, and the prediction accuracy may be good enough to still allow a reasonably long validity time for the ephemeris data when the ephemeris data is sent to a UE.

To this end, in conjunction with the preparation of a CHO configuration with a time-based CHO execution condition (i.e., involving the times T1 and T2 as previously described above), the network may use this prediction ability to provide satellite ephemeris data and Common TA parameters with an associated epoch time equal to T1 or set to some time between T1 and T2. This may serve to ensure, or at least increase the probability, that the ephemeris data and Common TA parameters are still valid if/when the UE executes the configured CHO.

More specifically, for example, a candidate target node may receive information about T1 and T2 (e.g., in the form of a UTC (representing T1) and a duration (where adding the duration to T1 results in T2)) in the HANDOVER REQUEST XnAP message from the source node. With this information, the target node may determine ephemeris data and Common TA parameters pertaining to the satellite serving the candidate target cell (or the satellite that will serve the candidate target cell at time T1) with an epoch time set to T1 or some time between T1 and T2. The candidate target node may then put this ephemeris data and the Common TA parameters in the HandoverCommand (i.e., the RRCReconfiguration the UE should apply if/when executing the CHO in the candidate target cell) that is sent to the source node in the HANDOVER REQUEST ACKNOWLEDGE XnAP message to be forwarded to the UE.

As an alternative, a central unit, such as an O&M node, or a node that is specific to NTN, such as a satellite command node or a satellite control node or satellite monitoring node, may determine the ephemeris data and Common TA parameters and provide them to the source node for forwarding to the UE as a part of the CHO configuration.

As another alternative, a central unit, such as an O&M node, or a node that is specific to NTN, such as a satellite command node or a satellite control node or satellite monitoring node, may provide extensive and/or elaborate (e.g. with extra high accuracy) ephemeris data and/or Common TA parameters to the source node, and this ephemeris data and/or Common TA parameters are associated with a satellite serving a candidate target cell in a CHO configuration for a UE. From this ephemeris data and/or Common TA parameters, the source node derives ephemeris data and/or Common TA parameters with an associated epoch time equal to T1 or some time between T1 and T2 (wherein T1 and T2 are part of a time-based CHO execution condition in the CHO configuration) and sends this ephemeris data and/or Common TA parameters to the UE to form part of the CHO configuration (e.g., as fields/parameters in the CondReconfigToAddMod-r16 IE), in a particular embodiment.

In a further particular embodiment, the central node may provide such extensive and/or elaborate ephemeris and Common TA information associated with multiple satellites (some or all of which may serve potential target cells for HO or potential candidate target cells for CHOs) and may do so regularly (e.g., periodically).

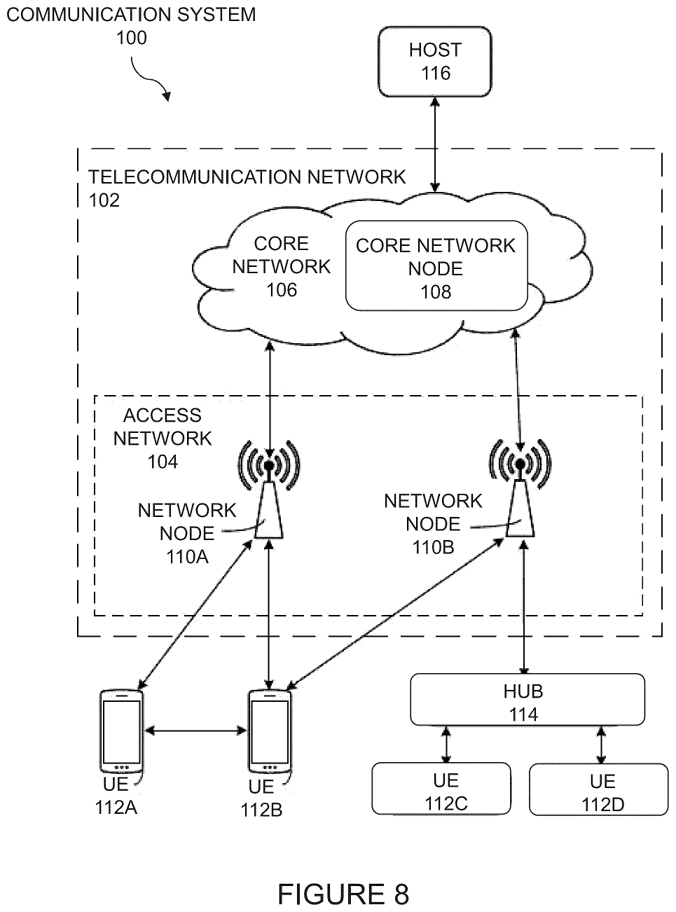

FIG. 8 shows an example of a communication system QQ100 in accordance with some embodiments. In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM): Universal Mobile Telecommunications System (UMTS): Long Term Evolution (LTE), and/or other suitable 2G, 3G, 4G, 5G standards, or any applicable future generation standard (e.g., 6G): wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (cMBB) services to other UEs, and/or Massive Machine Type Communication (mMTC)/Massive IoT services to yet further UEs. In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

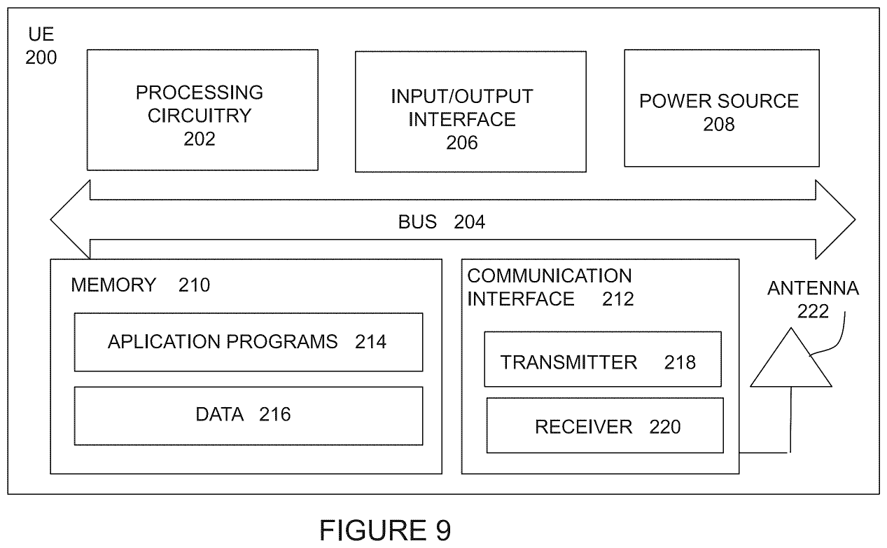

FIG. 9 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware: one or more stored computer programs, general-purpose processors, such as a microprocessor or digital signal processor (DSP), together with appropriate software: or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

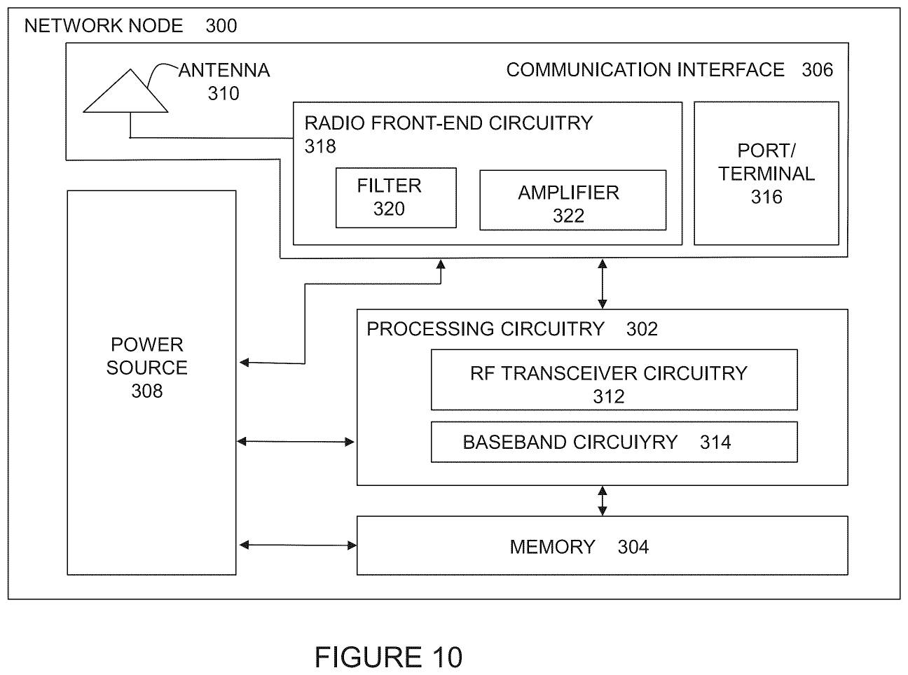

FIG. 10 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

he antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 10 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

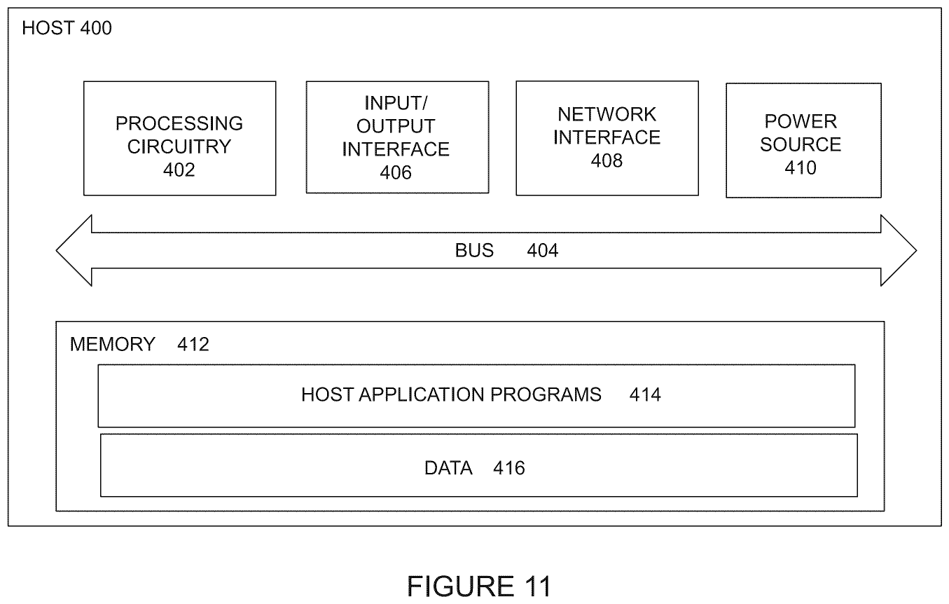

FIG. 11 is a block diagram of a host QQ400, which may be an embodiment of the host QQ116 of FIG. 8, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

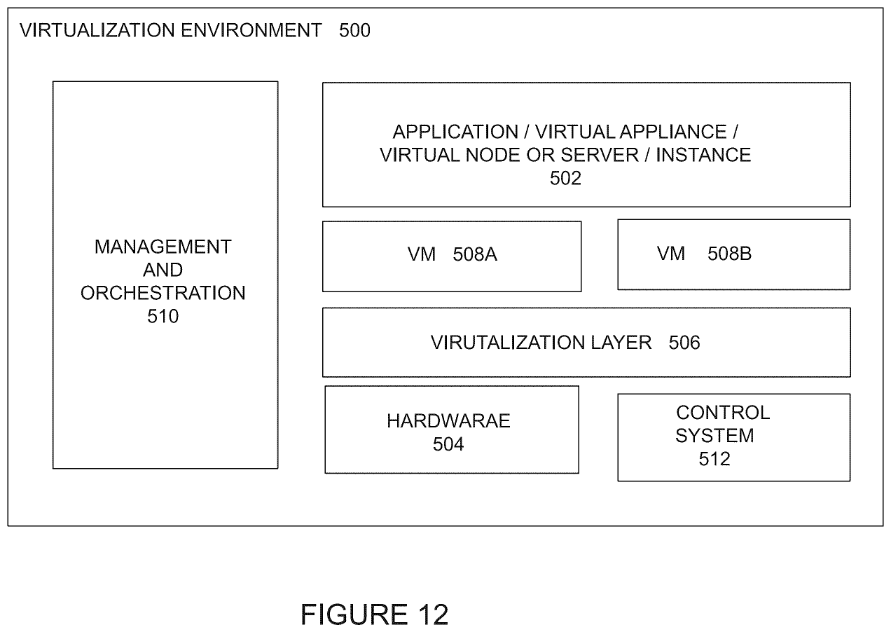

FIG. 12 is a block diagram illustrating a virtualization environment QQ500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

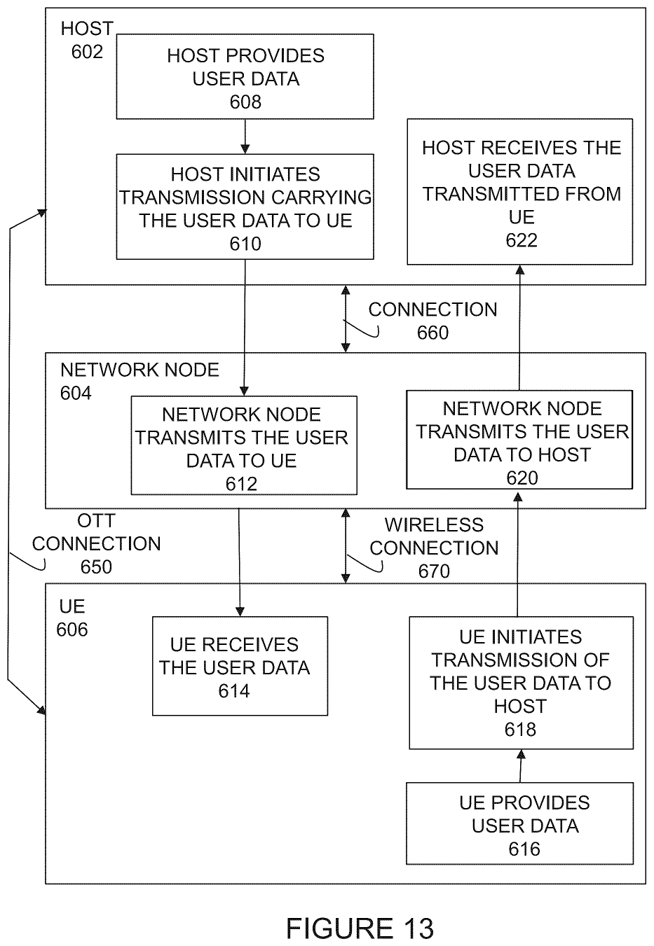

FIG. 13 shows a communication diagram of a host QQ602 communicating via a network node QQ604 with a UE QQ606 over a partially wireless connection in accordance with some embodiments.

Example implementations, in accordance with various embodiments, of the UE (such as a UE QQ112a of FIG. 8 and/or UE QQ200 of FIG. 9), network node (such as network node QQ110a of FIG. 8 and/or network node QQ300 of FIG. 10), and host (such as host QQ116 of FIG. 8 and/or host QQ400 of FIG. 11) discussed in the preceding paragraphs will now be described with reference to FIG. 13.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 8) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes: the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.: the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

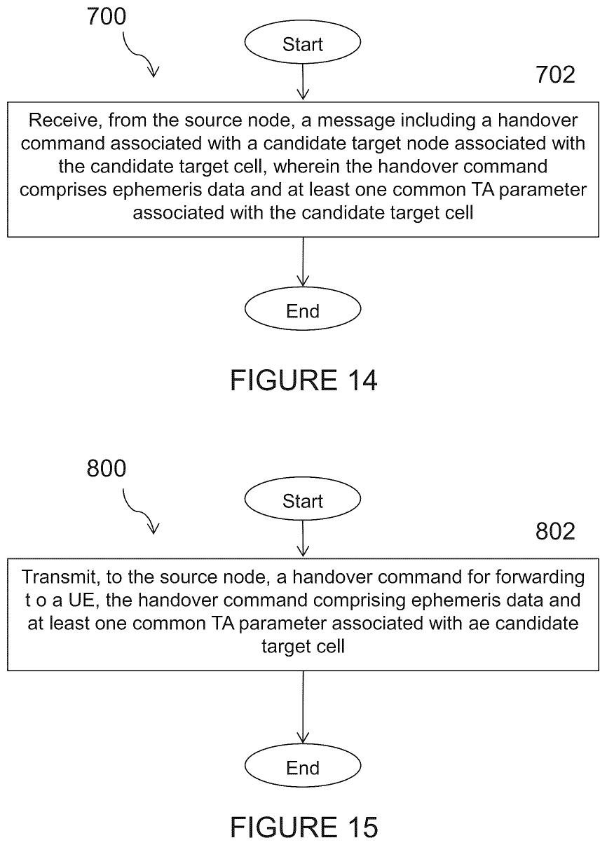

FIG. 14 illustrates a method 700 by a UE 112 during a HO of the UE 112 from a source cell associated with a source node to a candidate target cell associated with a candidate target node, according to certain embodiments. The method includes receiving, at step 702, from the source node, a message including a HO command associated with the candidate target node associated with the candidate target cell. The HO command includes ephemeris data and at least one common TA parameter associated with the candidate target cell.

In a particular embodiment, the target node and/or the source node is a network node such as, for example, a gNB.

In a particular embodiment, the HO command is comprised in a condRRCReconfig-r16 information element.

In a particular embodiment, the message comprises a CHO configuration associated with the HO command, and the CHO configuration includes at least one condition associated with the execution of the HO.

In a particular embodiment, the ephemeris data and the at least one common TA parameter are associated with a validity time.

In a further particular embodiment, in response to determining that the at least one condition has been fulfilled, the UE determines whether the validity time associated with the ephemeris data and the at least one common TA parameter is expired. If the validity time is not expired, the UE uses the ephemeris data and the at least one common TA parameter to calculate a first TA. Based on the calculated first TA, the UE transmits a RA message to the candidate target node associated with the candidate target cell. Alternatively, if the validity time has expired, the UE obtains updated ephemeris data and at least one updated common TA parameter and uses the updated ephemeris data and the at least one updated common TA parameter to calculate a second TA. Based on the calculated second TA, the UE transmits a RA message to the candidate target node associated with the candidate target cell.

In a particular embodiment, prior to determining that the at least one condition has been fulfilled, the UE determines whether the validity time associated with the ephemeris data and the at least one common TA parameter is expired. If the validity time is not expired and when the at least one condition subsequently has been fulfilled, the UE uses the ephemeris data and the at least one common TA parameter to calculate a first TA and, based on the calculated TA, transmits a RA message to the target node associated with the target candidate cell. Or, if the validity time has expired, the UE obtains updated ephemeris data and at least one updated common TA parameter from system information broadcast in the candidate target cell.

In a particular embodiment, prior to determining that the at least one condition has been fulfilled, the UE determines whether the validity time associated with the ephemeris data and the at least one common TA parameter is expired. If the validity time is not expired and when the at least one condition subsequently has been fulfilled, the UE uses the ephemeris data and the at least one common TA parameter to calculate a first TA and, based on the calculated TA, transmits a RA message to the candidate target node associated with the candidate target cell. Or, if the validity time has expired and prior to the at least one condition being fulfilled, the UE obtains updated ephemeris data and at least one updated common TA parameter from system information broadcast in the candidate target cell and monitors for the at least one condition to be fulfilled. In response to determining that the at least one condition has been fulfilled, the UE uses the updated ephemeris data and the at least one updated common TA parameter to calculate a second TA. Based on the calculated TA, the UE transmits a RA message to the target node for the target candidate cell.

In a particular embodiment, when obtaining the updated ephemeris data and the at least one updated common TA parameter, the UE performs at least one of: receiving at least one of the updated ephemeris data and the at least one updated common TA parameter in SI broadcast by the candidate target node and receiving at least one of the updated ephemeris data and/or the at least one updated common TA parameter from the source node.

In a particular embodiment, the UE receives, from the candidate target node or the source node, updated ephemeris data and at least one updated common TA parameter associated with the candidate target cell. The updated ephemeris data and the at least one updated common TA parameter are associated with an updated validity time.

In a particular embodiment, in response to determining that the at least one condition has been fulfilled and that the updated validity time associated with the updated ephemeris data and the at least one updated common TA parameter is not expired, the UE uses the updated ephemeris data and the at least one updated common TA parameter to calculate an updated TA. Based on the calculated updated TA, the UE transmits a RA message to the candidate target node associated with the candidate target cell.

In a particular embodiment, the ephemeris data and the at least one common TA parameter is associated with a satellite serving the candidate target cell associated with the candidate target node.

FIG. 15 illustrates a method 800 by a target node during a HO of a UE 112 from a source cell associated with a source node to a candidate target cell associated with the target node, according to certain embodiments. The method includes transmitting, to the source node, a HO command for forwarding to the UE, at step 802. The HO command includes ephemeris data and at least one common TA parameter associated with the candidate target cell.

In a particular embodiment, the target node and/or the source node is a network node such as, for example, a gNB.

In a particular embodiment, the HO command is a CHO command and/or configuration, and the CHO configuration includes at least one condition associated with the HO.

In a particular embodiment, the ephemeris data and the at least one common TA parameter is associated with a validity time.

In a further particular embodiment, the validity time is included in the HO command.

In a particular embodiment, the target node determines that the validity time associated with the ephemeris data and the at least one common TA parameter is expired or will expire within a threshold amount of time. In response to determining that the validity time is expired or will expire within the threshold amount of time, the target node determines whether to transmit updated ephemeris data and at least one updated common TA parameter.

In a particular embodiment, the target node determines whether to transmit the updated ephemeris data and the at least one updated common TA parameter based on a traffic load or processing load of the target node.

In a particular embodiment, the target node receives an indication from the source node that the target node is to provide updated ephemeris data and the at least one updated common TA parameter.

In a particular embodiment, when determining that the validity time is expired or will expire within a threshold amount of time, the target node monitors a timer associated with the validity time and determines, based on the timer, that the validity time associated with the ephemeris data and the at least one common TA parameter is expired or will expire within a threshold amount of time.

In a particular embodiment, the target node transmits updated ephemeris data and at least one updated common TA parameter.

In a particular embodiment, when transmitting the updated ephemeris data and the at least one updated common TA parameter, the target node performs at least one of: broadcasting the updated ephemeris data and the at least one updated common TA parameter in system information to the UE; and transmitting an updated HO command to the source node for forwarding to the UE, wherein the updated HO command comprises the updated ephemeris data and the at least one updated common TA parameter.

In a particular embodiment, the updated HO command comprises at least one of: an in indication that the previous HO command and/or a HO configuration associated with the previous HO command is cancelled: an indication that a validity time associated with the ephemeris data and the at least one common TA parameter is expired or will expire within a threshold amount of time; and an indication that the updated HO command comprises updated data that is not associated with ephemeris data, the at least one common TA parameter, and/or the validity time that is associated therewith.

In a particular embodiment, the target node receives a request for updated ephemeris data and at least one updated common TA parameter.

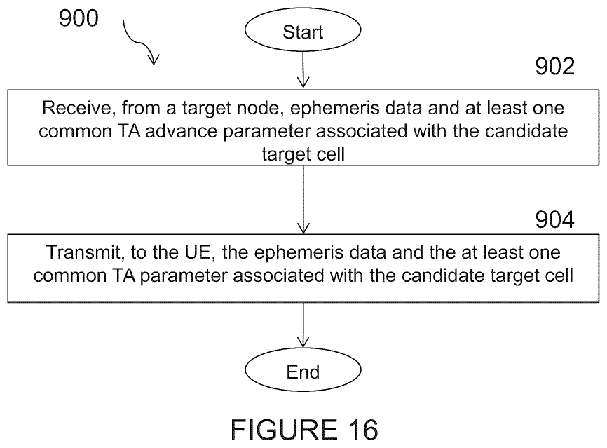

FIG. 16 illustrates a method by a source node during a HO of a UE 112 from a source cell associated with the source node to a candidate target cell associated with a target node, according to certain embodiments. The method includes, at step 902, the source node receiving, from a target node, ephemeris data and at least one common TA parameter associated with the candidate target cell. At step 904, the source node transmits, to the UE 112, the ephemeris data and the at least one common TA parameter associated with the candidate target cell.

In a particular embodiment, the target node and/or the source node is a network node such as, for example, a gNB.

In a particular embodiment, the ephemeris data and the at least one common TA parameter is received in a HO command from a target node.

In a particular embodiment, the HO command is a CHO command and/or CHO configuration, and the CHO configuration includes at least one condition associated with the HO.

In a particular embodiment, the HO command is comprised in a condRRCReconfig-r16 information element.

In a particular embodiment, the ephemeris data and the at least one common TA parameter are received from a network node, and the network node comprises an O&M node, a NTN-specific node, a satellite command node, a satellite control node, or a satellite monitoring node.

In a particular embodiment, the ephemeris data and the at least one common TA parameter is associated with a validity time.

In a particular embodiment, the validity time is included in a message that includes the ephemeris data and the at least one common TA parameter.

In a particular embodiment, the source node determines that the validity time associated with the ephemeris data and the at least one common TA parameter is expired or will expire within a threshold amount of time. In response to determining that the validity time is expired or will expire within a threshold amount of time, the source node determines whether to request updated ephemeris data and at least one updated common TA parameter.

In a particular embodiment, when determining that the validity time is expired or will expire within a threshold amount of time, the source node monitors a timer associated with the validity time and determines, based on the timer, that the validity time associated with the ephemeris data and the at least one common TA parameter is expired or will expire within a threshold amount of time.

In a particular embodiment, the source node determines whether to request the updated ephemeris data and the at least one updated common TA parameter based on a traffic load or processing load of the source node.

In a particular embodiment, the source node transmits a request for the updated ephemeris data and the at least one updated common TA parameter.

In a particular embodiment, the request is transmitted to the target node or a network node that comprises an O&M node, a NTN-specific node, a satellite command node, a satellite control node, or a satellite monitoring node.

In a particular embodiment, the source node receives updated ephemeris data and at least one updated common TA parameter.

In a particular embodiment, based on a traffic load or processing load of the source node and/or UE, the source node determines whether to transmit the updated ephemeris data and the at least one updated common TA parameter to the UE.

In a particular embodiment, the source node transmits the updated ephemeris data and the at least one updated common TA parameter to the UE.

In a particular embodiment, the updated ephemeris data and the at least one updated common TA parameter is transmitted to the UE in an updated HO command.

In a particular embodiment, the updated ephemeris data and the at least one updated common TA parameter is received from the target node in an updated HO command.

In a particular embodiment, the updated HO command includes an in indication that a previous HO command and/or a HO configuration associated with is cancelled.

In a particular embodiment, the updated HO command includes an indication that the validity time associated with the ephemeris data and the at least one common TA parameter is expired or will expire within a threshold amount of time.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) during a HO of the UE from a source cell associated with a source node to a candidate target cell associated with a target node, the method comprising: receiving, from the source node, a HO command associated with the target node of the target candidate cell, the HO command comprising ephemeris data and at least one common TA parameter associated with the candidate target cell.

Example Embodiment C2. The method of Example Embodiment C1, wherein the HO command comprises a conditional HO command.

Example Embodiment C3. The method of any one of Example Embodiments C1 to C2, wherein the HO command comprises a conditional HO configuration, and wherein the conditional HO configuration comprises at least one condition associated with the HO.

Example Embodiment C4. The method of Example Embodiment C3, further comprising: determining that the at least one condition has been fulfilled; and executing the CHO configuration in response to determining that the at least one condition being fulfilled.

Example Embodiment C5. The method of any one of Example Embodiments C1 to C4, wherein the ephemeris data and the at least one common TA parameter is associated with a validity time.

Example Embodiment C6. The method of any one of Example Embodiments C4 and C5, further comprising: in response to determining that the at least one condition has been fulfilled, determining whether the validity time associated with the ephemeris data and the at least one common TA parameter is expired, and if the validity time is not expired: using the ephemeris data and the at least one common TA parameter to calculate a first TA, and based on the calculated TA, transmitting a RA message to the target node for the target candidate cell. Or, if the validity time has expired: obtaining updated ephemeris data and at least one updated common TA parameter, using the updated ephemeris data and the at least one updated common TA parameter to calculate a second TA, and based on the calculated TA, transmitting a RA message to the target node for the target candidate cell.

Example Embodiment C7. The method of any one of Example Embodiments C4 and C5, further comprising: prior to determining that the at least one condition has been fulfilled, determining whether the validity time associated with the ephemeris data and the at least one common TA parameter is expired, and if the validity time is not expired and after the at least one condition has been fulfilled: using the ephemeris data and the at least one common TA parameter to calculate a first TA, and based on the calculated TA, transmitting a RA message to the target node for the target candidate cell. Or, if the validity time has expired and after the at least one condition has been fulfilled: obtaining updated ephemeris data and at least one updated common TA parameter from SI broadcast in the candidate target cell, using the updated ephemeris data and the at least one updated common TA parameter to calculate a second TA, and based on the calculated TA, transmitting a RA message to the target node for the target candidate cell.

Example Embodiment C8. The method of any one of Example Embodiments C4 and C5, further comprising: prior to determining that the at least one condition has been fulfilled, determining whether the validity time associated with the ephemeris data and the at least one common TA parameter is expired, and if the validity time is not expired and the at least one condition has been fulfilled: using the ephemeris data and the at least one common TA parameter to calculate a first TA, and based on the calculated TA, transmitting a RA message to the target node for the target candidate cell. Or, if the validity time has expired and prior to the at least one condition being fulfilled: obtaining updated ephemeris data and at least one updated common TA parameter from SI broadcast in the candidate target cell, monitoring for the at least one condition to be fulfilled, in response to determining that the at least one condition has been fulfilled, using the updated ephemeris data and the at least one updated common TA parameter to calculate a second TA, and based on the calculated TA, transmitting a RA message to the target node for the target candidate cell.

Example Embodiment C9. The method of any one of Example Embodiments C6 to C8, wherein obtaining the updated ephemeris data and the at least one updated common TA parameter comprises: receiving the updated ephemeris data and the at least one updated common TA parameter in SI broadcast by the target node.

Example Embodiment C10. The method of any one of Example Embodiments C6 to C8, wherein obtaining the updated ephemeris data and the at least one updated common TA parameter comprises: receiving the updated ephemeris data and the at least one updated common TA parameter from the source node.

Example Embodiment C11. The method of any one of Example Embodiments C4 to C5, further comprising: receiving updated ephemeris data and at least one updated common TA parameter associated with the candidate target cell, the updated ephemeris data and the at least one updated common TA parameter is associated with an updated validity time.

Example Embodiment C12. The method of Example Embodiment C11, wherein receiving the updated ephemeris data and the at least one updated common TA parameter comprises: receiving the updated ephemeris data and the at least one updated common TA parameter in SI broadcast by the target node.

Example Embodiment C13. The method of Example Embodiment C11, wherein receiving the updated ephemeris data and the at least one updated common TA parameter comprises: receiving the updated ephemeris data and the at least one updated common TA parameter from the source node.

Example Embodiment C14. The method of any one of Example Embodiments C11 to C13, further comprising: in response to determining that the at least one condition has been fulfilled and that the updated validity time associated with the updated ephemeris data and the at least one updated common TA parameter is not expired: using the updated ephemeris data and the at least one updated common TA parameter to calculate an updated TA, and based on the calculated updated TA, transmitting a RA message to the target node for the target candidate cell.

Example Embodiment C15. The method of any one of Example Embodiments C11 to C14, wherein the validity time of the ephemeris data and the at least one common TA parameter is expired or is about to expire when the updated ephemeris data and the at least one updated common TA parameter is received.

Example Embodiment C16. The method of Example Embodiment C11, wherein receiving the updated ephemeris data and the at least one updated common TA parameter comprises: receiving the updated ephemeris data and the at least one updated common TA parameter from the source node.

Example Embodiment C17. The method of any one of Example Embodiments C1 to C6, wherein the ephemeris data and the at least one common TA parameter is associated with a satellite serving the candidate target cell associated with the target node.

Example Embodiment C18. The method of Example Embodiments C1 to C17, further comprising: providing user data; and forwarding the user data to a host via the transmission to the network node.

Example Embodiment C19. A user equipment comprising processing circuitry configured to perform any of the methods of Example Embodiments C1 to C18.

Example Embodiment C20. A user equipment adapted to perform any of the methods of Example Embodiments C1 to C15.

Example Embodiment C21. A wireless device comprising processing circuitry configured to perform any of the methods of Example Embodiments C1 to C18.

Example Embodiment C22. A computer program comprising instructions which when executed on a computer perform any of the methods of Example Embodiments C1 to C18.

Example Embodiment C23. A computer program product comprising computer program, the computer program comprising instructions which when executed on a computer perform any of the methods of Example Embodiments C1 to C18.

Example Embodiment C24. A non-transitory computer readable medium storing instructions which when executed by a computer perform any of the methods of Example Embodiments C1 to C18.

### Group D Example Embodiments

Example Embodiment D1. A method by a target node during a HO of a user equipment (UE) from a source cell associated with a source node to a candidate target cell associated with the target node, the method comprising: transmitting, to the source node, a HO command for forwarding to the UE, the HO command comprising ephemeris data and at least one common TA parameter associated with the candidate target cell.

Example Embodiment D2. The method of Example Embodiment D1, wherein the HO command comprises a CHO command.

Example Embodiment D3. The method of any one of Example Embodiments D1 to D2, wherein the HO command comprises a CHO configuration, and wherein the CHO configuration comprises at least one condition associated with the HO.

Example Embodiment D4. The method of Example Embodiment D3, further comprising: determining that the at least one condition has been fulfilled; and executing the CHO configuration in response to determining that the at least one condition being fulfilled.

Example Embodiment D5. The method of any one of Example Embodiments D1 to D4, wherein the HO command is transmitted to the source node in a HANDOVER REQUEST ACKNOWLEDGE XnAP message.

Example Embodiment D6A. The method of any one of Example Embodiments D1 to D5, wherein the ephemeris data and the at least one common TA parameter is associated with a validity time.

Example Embodiment D6B. The method of any one of Example Embodiment D6A, wherein the validity time is included in the HO command.

Example Embodiment D7. The method of any one of Example Embodiments D1 to D6B, further comprising: determining that the validity time associated with the ephemeris data and the at least one common TA parameter is expired or is about to expire (e.g., has less than a threshold amount of time left); and in response to determining that the validity time is expired or is about to expire, determining whether to transmit updated ephemeris data and at least one updated common

Example Embodiment D8A. The method of Example Embodiment D7, wherein the target node determines whether to transmit the updated ephemeris data and the at least one updated common TA parameter based on a traffic load or processing load of the target node.

Example Embodiment D8B. The method of any one of Example Embodiments D7 to D8A, further comprising receiving an indication from the source node that the target node is to provide updated ephemeris data and the at least one updated common TA parameter. TA parameter.

Example Embodiment D9. The method of any one of Example Embodiments D1 to D8B, further comprising transmitting updated ephemeris data and at least one updated common TA parameter.

Example Embodiment D10. The method of Example Embodiment D9, wherein transmitting the updated ephemeris data and the at least one updated common TA parameter comprises: broadcasting the updated ephemeris data and the at least one updated common TA parameter in SI to the UE.

Example Embodiment D11. The method of Example Embodiment D9, wherein transmitting the updated ephemeris data and the at least one updated common TA parameter comprises: transmitting an updated HO command to the source node for forwarding to the UE, wherein the updated HO command comprises the updated ephemeris data and the at least one updated common TA parameter.

Example Embodiment D12. The method of Example Embodiment D11, wherein the updated HO command comprises an in indication that the previous HO command and/or a HO configuration associated with the previous HO command is cancelled.

Example Embodiment D13. The method of any one of Example Embodiments D11 to D12, wherein the updated HO command comprises an indication that the validity time associated with the ephemeris data and the at least one common TA parameter is expired or is about to expire.

Example Embodiment D14. The method of any one of Example Embodiments D11 to D13, wherein the updated HO command comprises an indication that the updated HO command comprises updated data that is not associated with ephemeris data, the at least one common TA parameter, and/or a validity time that is associated therewith.

Example Embodiment D15. The method of any one of Example Embodiments D7 to D14, wherein determining that the validity time is expired or is about to expire comprises: monitoring a timer associated with the validity time; and determining, based on the timer, that the validity time associated with the ephemeris data and the at least one common TA parameter is expired or is about to expire (e.g., has less than a threshold amount of time left).

Example Embodiment D16. The method of any one of Example Embodiments D1 to D15, further comprising receiving a request for updated ephemeris data and an updated common TA parameter(s).

Example Embodiment D17. The method of any one of Example Embodiments D1 to D16, wherein the ephemeris data and the at least one common TA parameter is associated with a satellite serving the candidate target cell associated with the target node.

Example Embodiment D18. The method of any one of Example Embodiments D1 to D17, wherein the target node comprises a gNodeB (gNB).

Example Embodiment D19. The method of any of the previous Example Embodiments, further comprising: obtaining user data; and forwarding the user data to a host or a user equipment. Example Embodiment D20. A network node comprising processing circuitry configured to perform any of the methods of Example Embodiments D1 to D19.

Example Embodiment D21. A computer program comprising instructions which when executed on a computer perform any of the methods of Example Embodiments D1 to D19.

Example Embodiment D22. A computer program product comprising computer program, the computer program comprising instructions which when executed on a computer perform any of the methods of Example Embodiments D1 to D19.

Example Embodiment D23. A non-transitory computer readable medium storing instructions which when executed by a computer perform any of the methods of Example Embodiments D1 to D19.

### Group E Example Embodiments

Example Embodiment E1. A method by a source node during a HO of a user equipment (UE) from a source cell associated with the source node to a candidate target cell associated with a target node, the method comprising: receiving ephemeris data and at least one common TA parameter associated with the candidate target cell; and transmitting, to the UE, the ephemeris data and the at least one common TA parameter associated with the candidate target cell.

Example Embodiment E2. The method of Example Embodiment E1, wherein the ephemeris data and the at least one common TA parameter is received in a HO command from a target node.

Example Embodiment E3. The method of Example Embodiment E2, wherein the HO command comprises a conditional HO command.

Example Embodiment E4. The method of any one of Example Embodiments E2 to E3, wherein the HO command comprises a conditional HO configuration, and wherein the conditional HO configuration comprises at least one condition associated with the HO.

Example Embodiment E5. The method of any one of Example Embodiments E2 to E4, wherein the HO command is received from the target node in a HANDOVER REQUEST ACKNOWLEDGE XnAP message.

Example Embodiment E6. The method of Example Embodiment E1, wherein the ephemeris data and the at least one common TA parameter is received from a network node.

Example Embodiment E7. The method of Example Embodiment E6, wherein the network node comprises an O&M node, a NTN-specific node, a satellite command node, a satellite control node, or a satellite monitoring node.

Example Embodiment E8. The method of any one of Example Embodiments E1 to E7, wherein the ephemeris data and the at least one common TA parameter is associated with a validity time.

Example Embodiment E9. The method of any one of Example Embodiment E5, wherein the validity time is included in a message that includes the ephemeris data and the at least one common TA parameter.

Example Embodiment E10. The method of any one of Example Embodiments E8 to E9, further comprising: determining that the validity time associated with the ephemeris data and the at least one common TA parameter is expired or is about to expire (e.g., has less than a threshold amount of time left); and in response to determining that the validity time is expired or is about to expire, determining whether to request updated ephemeris data and at least one updated common TA parameter.

Example Embodiment E11A. The method of Example Embodiment E10, wherein determining that the validity time is expired or is about to expire comprises: monitoring a timer associated with the validity time; and determining, based on the timer, that the validity time associated with the ephemeris data and the at least one common TA parameter is expired or is about to expire (e.g., has less than a threshold amount of time left).

Example Embodiment E11B. The method of any one of Example Embodiments E10 to E11A, wherein the source node determines whether to request the updated ephemeris data and the at least one updated common TA parameter based on a traffic load or processing load of the source node

Example Embodiment E12. The method of Example Embodiment E10 to E11B, further comprising transmitting a request for the updated ephemeris data and the at least one updated common TA parameter.

Example Embodiment E13. The method of Example Embodiment E12, wherein the request is transmitted to the target node.

Example Embodiment E14. The method of Example Embodiment E12, wherein the request is transmitted to a network node that comprises an O&M node, a NTN-specific node, a satellite command node, a satellite control node, or a satellite monitoring node.

Example Embodiment E15. The method of any one of Example Embodiments E1 to E14, further comprising transmitting an indication that a source of the ephemeris data and the at least one common TA parameter is to provide updated ephemeris data and updated common TA parameter(s).

Example Embodiment E16. The method of any one of Example Embodiments E1 to E15, further comprising receiving updated ephemeris data and at least one updated common TA parameter.

Example Embodiment E17. The method of Example Embodiment E16, further comprising determining whether to transmit the updated ephemeris data and the at least one updated common TA parameter to the UE.

Example Embodiment E18. The method of Example Embodiment E17, wherein the source node determines whether to transmit the updated ephemeris data and the at least one updated common TA parameter based on a traffic load or processing load of the source node and/or UE.

Example Embodiment E19. The method of any one of Example Embodiments E16 to E18, further comprising transmitting the updated ephemeris data and the at least one updated common TA parameter to the UE.

Example Embodiment E20. The method of Example Embodiment E19, wherein transmitting the updated ephemeris data and the at least one updated common TA parameter comprises: transmitting, to the UE, the updated ephemeris data and the at least one updated common TA parameter in an updated HO command.

Example Embodiment E21. The method of any one of Example Embodiments E16 to E20, wherein the updated ephemeris data and the at least one updated common TA parameter is received from the target node in an updated HO command.

Example Embodiment E22. The method of Example Embodiment E21, wherein the updated HO command comprises an in indication that the previous HO command and/or a HO configuration associated with the previous HO command is cancelled.

Example Embodiment E23. The method of any one of Example Embodiments E21 to E22, wherein the updated HO command comprises an indication that the validity time associated with the ephemeris data and the at least one common TA parameter is expired or is about to expire.

Example Embodiment E24. The method of any one of Example Embodiments E21 to D23, wherein the updated HO command comprises an indication that the updated HO command comprises additional updated data that is not associated with the ephemeris data, the at least one common TA parameter, and/or a validity time that is associated therewith.

Example Embodiment E25. The method of Example Embodiment E24, further comprising: based on the indication that the updated HO command comprises the additional updated data, determining whether to forward the updated HO command to the UE.

Example Embodiment E26. The method of any one of Example Embodiments E1 to E25, wherein the ephemeris data and the at least one common TA parameter is associated with a satellite serving the candidate target cell associated with the target node.

Example Embodiment E27. The method of any one of Example Embodiments E1 to E26, wherein the network node comprises a gNodeB (gNB).

Example Embodiment E28. The method of any of the previous Example Embodiments, further comprising: obtaining user data; and forwarding the user data to a host or a user equipment.

Example Embodiment E29. A network node comprising processing circuitry configured to perform any of the methods of Example Embodiments E1 to E28.

Example Embodiment E30. A network node adapted to perform any of the methods of Example Embodiments E1 to E28.

Example Embodiment E31. A computer program comprising instructions which when executed on a computer perform any of the methods of Example Embodiments E1 to E28.

Example Embodiment E32. A computer program product comprising computer program, the computer program comprising instructions which when executed on a computer perform any of the methods of Example Embodiments E1 to E28.

Example Embodiment E33. A non-transitory computer readable medium storing instructions which when executed by a computer perform any of the methods of Example Embodiments E1 to E28.

### Group F Example Embodiments

Example Embodiment F1. A user equipment comprising: processing circuitry configured to perform any of the steps of any of the Group A and C Example Embodiments; and power supply circuitry configured to supply power to the processing circuitry.

Example Embodiment F2. A network node comprising: processing circuitry configured to perform any of the steps of any of the Group B, D, and E Example Embodiments: power supply circuitry configured to supply power to the processing circuitry.

Example Embodiment F3. A user equipment (UE) comprising: an antenna configured to send and receive wireless signals: radio front-end circuitry connected to the antenna and to processing circuitry, and configured to condition signals communicated between the antenna and the processing circuitry: the processing circuitry being configured to perform any of the steps of any of the Group A and C Example Embodiments: an input interface connected to the processing circuitry and configured to allow input of information into the UE to be processed by the processing circuitry: an output interface connected to the processing circuitry and configured to output information from the UE that has been processed by the processing circuitry; and a battery connected to the processing circuitry and configured to supply power to the UE.

Example Embodiment F4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment F5. The host of the previous Example Embodiment, wherein the cellular network further includes a network node configured to communicate with the UE to transmit the user data to the UE from the host.

Example Embodiment F6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment F8. The method of the previous Example Embodiment, further comprising: at the host, executing a host application associated with a client application executing on the UE to receive the user data from the UE.

Example Embodiment F9. The method of the previous Example Embodiment, further comprising: at the host, transmitting input data to the client application executing on the UE, the input data being provided by executing the host application, wherein the user data is provided by the client application in response to the input data from the host application.

Example Embodiment F10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment F11. The host of the previous Example Embodiment, wherein the cellular network further includes a network node configured to communicate with the UE to transmit the user data from the UE to the host.

Example Embodiment F12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment F14. The method of the previous Example Embodiment, further comprising: at the host, executing a host application associated with a client application executing on the UE to receive the user data from the UE.

Example Embodiment F15. The method of the previous Example Embodiment, further comprising: at the host, transmitting input data to the client application executing on the UE, the input data being provided by executing the host application, wherein the user data is provided by the client application in response to the input data from the host application.

Example Embodiment F16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, D, and E Example Embodiments to transmit the user data from the host to the UE.

Example Embodiment F17. The host of the previous Example Embodiment, wherein: the processing circuitry of the host is configured to execute a host application that provides the user data; and the UE comprises processing circuitry configured to execute a client application associated with the host application to receive the transmission of user data from the host. Example Embodiment F18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, D, and E Example Embodiments to transmit the user data from the host to the UE.

Example Embodiment F19. The method of the previous Example Embodiment, further comprising, at the network node, transmitting the user data provided by the host for the UE.

Example Embodiment F20. The method of any of the previous 2 Example Embodiments, wherein the user data is provided at the host by executing a host application that interacts with a client application executing on the UE, the client application being associated with the host application.

Example Embodiment F21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, D, and E Example Embodiments to transmit the user data from the host to the UE.

Example Embodiment F22. The communication system of the previous Example Embodiment, further comprising: the network node; and/or the user equipment.

Example Embodiment F23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, D, and E Example Embodiments to receive the user data from a user equipment (UE) for the host.

Example Embodiment F24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F25. The host of the any of the previous 2 Example Embodiments, wherein the initiating receipt of the user data comprises requesting the user data.

Example Embodiment F26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, D, and E Example Embodiments to receive the user data from the UE for the host.

Example Embodiment F27. The method of the previous Example Embodiment, further comprising at the network node, transmitting the received user data to the host.

1. A method by a user equipment, UE, during a handover of the UE from a source cell associated with a source node to a candidate target cell associated with a candidate target node, the method comprising:
receiving, from the source node, a message including a handover command associated with the candidate target node associated with the candidate target cell, the handover command comprising ephemeris data and at least one common Timing Advance, TA, parameter associated with the candidate target cell wherein the ephemeris data and the at least one common TA parameter are associated with a validity time.

2. The method of claim 1, wherein the handover command is comprised in a condRRCReconfig-r16 information element.

3. The method of claim 1, wherein the message comprises a conditional handover configuration associated with the handover command, wherein the conditional handover configuration comprises at least one condition associated with the execution of the handover.

4. (canceled)

5. The method of claim 1, comprising:
in response to determining that the at least one condition has been fulfilled, determining whether the validity time associated with the ephemeris data and the at least one common TA parameter is expired, and
if the validity time is not expired:
using the ephemeris data and the at least one common TA parameter to calculate a first TA, and
based on the calculated first TA, transmitting a RA message to the candidate target node associated with the candidate target cell, or
if the validity time has expired:
obtaining updated ephemeris data and at least one updated common TA parameter,
using the updated ephemeris data and the at least one updated common TA parameter to calculate a second TA, and
based on the calculated second TA, transmitting a RA message to the candidate target node associated with the candidate target cell.

6. The method of claim 1, comprising:
prior to determining that the at least one condition has been fulfilled, determining whether the validity time associated with the ephemeris data and the at least one common TA parameter is expired, and
if the validity time is not expired and when the at least one condition subsequently has been fulfilled:
using the ephemeris data and the at least one common TA parameter to calculate a first TA, and
based on the calculated first TA, transmitting a RA message to the target node associated with the target candidate cell, or
if the validity time has expired:
obtaining updated ephemeris data and at least one updated common TA parameter from system information broadcast in the candidate target cell.

7. The method of claim 1, comprising:
prior to determining that the at least one condition has been fulfilled, determining whether the validity time associated with the ephemeris data and the at least one common TA parameter is expired, and
if the validity time is not expired and when the at least one condition subsequently has been fulfilled:
using the ephemeris data and the at least one common TA parameter to calculate a first TA, and
based on the calculated first TA, transmitting a RA message to the candidate target node associated with the candidate target cell, or if the validity time has expired and prior to the at least one condition being fulfilled:
obtaining updated ephemeris data and at least one updated common TA parameter from system information broadcast in the candidate target cell,
monitoring for the at least one condition to be fulfilled,
in response to determining that the at least one condition has been fulfilled, using the updated ephemeris data and the at least one updated common TA parameter to calculate a second TA, and
based on the calculated second TA, transmitting a RA message to the target node for the target candidate cell.

8. (canceled)

9. The method of claim 1, comprising:
receiving, from the candidate target node or the source node, updated ephemeris data and at least one updated common TA parameter associated with the candidate target cell, the updated ephemeris data and the at least one updated common TA parameter are associated with an updated validity time.

10. The method of claim 9, comprising:
in response to determining that the at least one condition has been fulfilled and that the updated validity time associated with the updated ephemeris data and the at least one updated common TA parameter is not expired:
using the updated ephemeris data and the at least one updated common TA parameter to calculate an updated TA, and
based on the calculated updated TA, transmitting a RA message to the candidate target node associated with the candidate target cell.

11.-23. (canceled)

24. A method by a source node during a handover of a user equipment, UE, from a source cell associated with the source node to a candidate target cell associated with a target node, the method comprising:
receiving, from a target node, ephemeris data and at least one common timing advance, TA, parameter associated with the candidate target cell; and
transmitting, to the UE, the ephemeris data and the at least one common TA parameter associated with the candidate target cell, wherein the ephemeris data and the at least one common TA parameter is associated with a validity time.

25. The method of claim 24, wherein the ephemeris data and the at least one common TA parameter is received in a handover command from a target node.

26. The method of claim 25, wherein the handover command comprises a conditional handover command and/or configuration, and wherein the conditional handover configuration comprises at least one condition associated with the handover.

27. The method of claim 25, wherein the handover command is comprised in a condRRCReconfig-r16 information element.

28. The method of claim 25, wherein the ephemeris data and the at least one common TA parameter are received from a network node, and wherein the network node comprises an O&M node, a NTN-specific node, a satellite command node, a satellite control node, or a satellite monitoring node.

29. (canceled)

30. (canceled)

31. The method of claim 24, comprising:
determining that the validity time associated with the ephemeris data and the at least one common TA parameter is expired or will expire within a threshold amount of time; and
in response to determining that the validity time is expired or will expire within a threshold amount of time, determining whether to request updated ephemeris data and at least one updated common TA parameter.

32. (canceled)

33. The method of claim 31, wherein the source node determines whether to request the updated ephemeris data and the at least one updated common TA parameter based on a traffic load or processing load of the source node.

34. The method of claim 31, comprising transmitting a request for the updated ephemeris data and the at least one updated common TA parameter.

35.-36. (canceled)

37. The method of claim 31, comprising, based on a traffic load or processing load of the source node and/or UE, determining whether to transmit the updated ephemeris data and the at least one updated common TA parameter to the UE.

38.-39. (canceled)

40. The method of, wherein the updated ephemeris data and the at least one updated common TA parameter is received from the target node in an updated handover command.

41. (canceled)

42. The method of claim 34, wherein the updated handover command comprises an indication that the validity time associated with the ephemeris data and the at least one common TA parameter is expired or will expire within a threshold amount of time.

43. A user equipment, UE, during a handover of the UE from a source cell associated with a source node to a candidate target cell associated with a target node, the UE adapted to:
receive, from the source node, a handover command associated with the target node of the target candidate cell, the handover command comprising ephemeris data and at least one common TA parameter associated with the candidate target cell, wherein the ephemeris data and the at least one common TA parameter is associated with a validity time.

44.-46. (canceled)

47. A source node adapted, during a handover of a user equipment, UE, from a source cell associated with the source node to a candidate target cell associated with a target node, to:
receive, from a target node, ephemeris data and at least one common timing advance, TA, parameter associated with the candidate target cell; and
transmit, to the UE, the ephemeris data and the at least one common TA parameter associated with the candidate target cell, wherein the ephemeris data and the at least one common TA parameter is associated with a validity time.

48. (canceled)
